(19) United States
(12) Patent Application Publication
(10) Pub. No.: US 2006/0269110 A1
(43) Pub. Date: Nov. 30, 2006

(54) Computer system for efficient design and manufacture of multiple-component devices

(76) Inventors: George A. Lopez, Laguna Beach, CA (US); Craig Perkins, San Clemente, CA (US); Doug Bregman, San Clemente, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/417,919

(22) Filed: May 3, 2006

Related U.S. Application Data
(63) Continuation of application No. 11/146,470, filed on Jun. 7, 2005.
(60) Provisional application No. 60/579,230, filed on Jun. 14, 2004.

(51) Int. Cl. G06K 9/00

(52) U.S. Cl. 382/128

(57) ABSTRACT

Embodiments of the disclosed computer systems provide rapid design of multiple component products, especially medical products, as well as determination of manufacturing costs, pricing, physical attributes, component bonding techniques, sterilization techniques, and government regulatory approval. Certain embodiments also generate work orders, product labels, and audits for multiple component devices.

### RELATED APPLICATIONS

Priority Claim

This application is a continuation of U.S. patent application Ser. No. 11/146,470, filed Jun. 7, 2005, which claims the benefit of U.S. Provisional Patent Application No. 60/579,230, filed on Jun. 14, 2004.

Incorporation by Reference

This application hereby incorporates by reference U.S. Provisional Patent Application No. 60/579,230, filed on Jun. 14, 2004; U.S. patent application Ser. No. 10/398,432, filed on Apr. 26, 2004, and entitled “Method of Manufacturing a Multiple Component Device” (published on Sep. 9, 2004 as US 2004-0176867 A1); and U.S. patent application Ser. No. 09/213,138, filed on Dec. 16, 1998 and entitled “System and Method for Browsing and Comparing Products” (published as a PCT application on Jul. 6, 2000 as PCT US 99/30317), in their entireties.

### BACKGROUND OF THE INVENTION

1. Field of the Invention

The present invention generally relates to computer systems for designing and manufacturing multiple component devices. More particularly, the invention relates to computer systems for managing the design, pricing, prototype generation and manufacturing processes of products made from interchangeable multiple components.

2. Description of the Related Technology

The design and manufacture of devices with multiple, interchangeable component parts is a complicated process involving many phases. The individual components in such devices typically interconnect and function together in a variety of different possible configurations. Existing ways of managing the design and manufacturing processes of multiple component devices are very inefficient and unresponsive to the varied and ever-changing needs of customers. The many disadvantages of the present systems and methods include inflexibility, high cost, repetitive labor, expensive and unnecessary human involvement, and long time delays.

For example, current systems and methods of designing and manufacturing multiple component devices involve lengthy times to design a device that is the lowest cost solution meeting the functional requirements for the device. Data required to produce the optimal design, including cross reference information on competitors' devices or components, is not readily available. In addition, designers typically undergo the entire design process all over again for each new service, even when previously designed devices are very similar or identical to the new device. Similarly, designers qualify and validate each device for regulatory approval, if required, even if very similar or identical to a previously approved device. Regulatory approval can be the lengthiest phase of designing and manufacturing a device, requiring extensive human labor, and producers typically do not take advantage of the approvals of previously designed devices.

Additionally, it is time-consuming to produce a manufacturing work order for the designed device that is accurate and free of errors or omissions. Also, in part because of the lag between the design and manufacturing phases, efficient inventory management is difficult since components and other parts needed to manufacture the device cannot be pre-ordered until the manufacturing facility receives the completed manufacturing order. Still further, it is difficult to select the optimal manufacturing location because data regarding current labor rates, currency exchange rates, and the present workload of various locations is not readily accessible.

Present systems and methods also involve the time consuming manual calculation and measurement of physical characteristics of the device, for example, the size, weight and volume of the device. The physical characteristics of each device are manually calculated or measured for each product configuration requested by a consumer, regardless of whether the device is very similar or identical to a previously manufactured device. In addition, in some fields, devices undergo a particular type of processing or treatment, such as sterilization, prior to shipping to the customer, and processing treatment is often not arranged or scheduled until the manufacturing phase is complete, again introducing additional inefficiencies and potential for delays. Further, customers desiring the status of an order will generally telephone customer service representatives who investigate the status and report back to the customer. Hiring, training, and employing customer service representatives adds significant overhead cost to the production of the devices.

The many problems described above in designing and manufacturing multiple component devices are especially prevalent in the medical device industry. For example, medical practitioners often require intravenous (IV) sets that incorporate a variety of components when caring for hospitalized patients. The components of an IV set can include IV drip bags, medical tubing, needleless injection sites, Y-sites, luer connectors, and other IV set components. Many of these components are repeatedly used together in certain configurations for specific applications at a given hospital or other health care facility, but the components are often sold separately by separate manufacturers. Certain practitioners or health care facilities may prefer multi-component configurations of products provided by different manufacturers, and each component may be available in different sizes, shapes, and materials.

As an example, in the medical device field, a customer may inquire about the design and potential purchase of a certain quantity of an IV set that has not yet been produced by the particular manufacturer by specifying to the manufacturer or a distributor the desired parameters and configuration of the device in sufficient detail to allow the manufacturer to design the set. Having received the necessary parameters for the IV set, the manufacturer or distributor proceeds to design the set. The design and manufacture of the IV set is typically a relatively lengthy and time-consuming process, and all of the various phases of this process may take 2-3 weeks, a month, or even longer, depending on the complexity of the set, the type of testing required to ensure that the set meets the specified requirements, and the complex and lengthy regulatory approval process. Given these requirements a manufacturer of such devices may employ a large number of designers to perform the design work at significant cost to the manufacturer.

When mass-producing devices, certain fixed costs are recovered by aggregating the costs over the total number of devices produced. When the order is for a large number of devices, the fixed costs added to the price of each device are lower than for an order of only a small number of devices. This is sometimes referred to as “economies of scale.” However, economies of scale are lost when making a relatively small number of specialized devices. In these cases, it is especially important to minimize the fixed costs, for example, design costs, in order to enable the order to be filled profitably while being affordably priced. Current systems do not reduce fixed costs such that small orders can be profitably filled at an affordable price.

In addition to considering the functional requirements of the device, the designer may also consider the cost of various alternative designs and select the most cost-efficient design that meets the specified functional requirements. For example, there may be several potential designs that fully satisfy the functional requirements of an IV set. However, some of these designs may incorporate one or more components not included in other designs or use expensive components for which lower cost alternatives can be substituted. In this case, the designer typically chooses the design that incorporates fewer or cheaper component parts to minimize cost while still meeting the requirements specified for the device. Therefore, as is apparent from this example, the design process is complicated by the fact that the designer typically must balance multiple design parameters that are often conflicting before arriving at the final, optimal design of the desired device. However, the designers may not always be aware of the full spectrum of products available from various manufacturers.

Customers who inquire about the purchase of multiple component devices often also inquire about competitors' products or components, or request a component be included in the desired device that is equivalent in function to a competitor's components. Existing ways of designing multiple component devices typically do not provide readily-available access to information about competitors' products and provide no way to enable the designer to easily substitute the equivalent of a certain competitor's component into the desired device. This often leads to frustration by the customer and results in the customer placing the order with the competitor whose products or components are better known by the customer.

Further complicating the design and manufacture of medical devices is the qualification and validation requirements mandated by the U.S. Food and Drug Administration (FDA), an agency of the Department of Health and Human Services of the federal government. In the interest of public health and safety, the FDA regulates the manufacture and use of drugs and many medical devices. IV sets are an example of medical devices that are subject to FDA regulations involving the qualification and validation of the IV sets prior to use on a patient. Multiple component devices in other fields are also subject to qualification and validation by regulatory agencies.

The FDA qualification and validation requirements add still more complexity and delay to the design and manufacturing processes of multiple component medical devices. In existing methods of designing medical devices based on a customer inquiry, each new configuration is formally qualified to ensure compliance with all applicable FDA regulations. When a customer inquires about a new medical device such as an IV set, the manufacturer must conduct FDA qualification and validation all over again. This is the case even when the IV set is very similar to another IV set that the manufacturer designed and manufactured for the customer, or for another customer. Obviously, performing the qualification and validation all over again for each new set is an inefficient and time consuming process, especially in the case where the device is very similar or identical to a previously qualified and validated set. While it is possible to keep records on IV sets that have been previously designed and manufactured, there are potentially such a large number of configurations and variations of sets that managing them becomes a more time consuming task than merely redoing the qualification and validation.

Because the FDA qualification and validation process is a fairly lengthy and time consuming examination and testing process, it sometimes adds weeks to the design time before the medical device is approved for manufacturing. Companies generally do not begin manufacturing a medical device until FDA qualification and validation is successfully completed because manufacturing would have to be halted if qualification and validation fails and started up again after altering the design to correct the cause of the failure. Clearly, this can add significantly to the costs of designing and manufacturing the device.

Once the design of the desired medical device has been completed, tested, and qualified for FDA approval, the manufacturer determines the price for producing the device in the indicated quantity and provides the price quote to the customer. The price for each device includes the cost of the individual components, the labor for assembling the device, the labor for testing/certifying the device, the shipping costs, and certain fixed costs for producing the device. The price per device generally depends on how many of the devices the customer indicates will eventually by ordered, as the fixed costs are spread over the total number of devices produced. For example, design of the device is one cost that is constant whether one device is produced or 10,000 devices are produced. The more devices that the customer orders, the more devices over which the design costs can be spread, thus lowering the cost per device.

Once the customer agrees to the quoted price and places an order for the device, the designer or the manufacturing facility typically generates a work order that may include a bill of materials listing the components required and the labor steps involved in assembling the device. This is typically performed manually, which is time consuming and increases the chance that a human error may be introduced into the work order. Such an error in the work order has the potential to be very costly, as it is possible that many devices could be manufactured that do not meet the design requirements before the error is discovered. Typically, these nonconforming devices are discarded and the associated waste costs would reduce or even completely eliminate the profit that the manufacturer anticipated making from filling the order. Most companies increase the price of their products to offset the occurrence of such errors and protect against erosion of the profits caused by manufacturing nonconforming devices, making it more difficult to be cost competitive in a highly competitive marketplace.

An additional inefficiency in existing ways of designing multiple component devices involves the case where a customer inquires about a device that is very similar to a device the same customer has ordered in the past, but with a few minor variations. In this case, the manufacturer begins the design process from the beginning because each new product, no matter how slight the difference from the old product, may require regulatory approval. Even if the manufacturer is able to identify a similar prior device, some of the steps in the design process may nonetheless still be performed again, such as determining the price of the similar but different device or performing the testing/certifying of the device.

Once the design phase has been completed, the customer reviews a sample of the product and agrees to the price quote for the devices to be ordered, which could be weeks or even months after the initial inquiry is made by the customer. The manufacturing process then begins based on the work order. The detailed design specifications sufficient for manufacturing purposes are sent from the device designer to the manufacturing facility. The designer can order the components necessary to manufacture the device, or the manufacturing division can order the components once the design specifications are received. The components can also be maintained in inventory, but this presents inventory management problems in having the proper number of each component in stock and in special ordering components that are rarely used or that must be custom made. In addition, maintaining an inventory of products presents cash flow problems and increases production costs, as components for inventory must be ordered in advance of being purchased by customers for manufacturing into completed devices. If a large order is placed by a customer, it is unlikely that the available inventory will be sufficient to fill the order, thereby further delaying the time for actual delivery of the devices.

The manufacturing facility may be at a separate location than the design facility. For example, the manufacturing facility may be located in places with lower labor costs. In addition, the manufacturing process may be split between more than one manufacturing locations. This introduces further logistical difficulties in managing and tracking orders and ensuring a smooth manufacturing flow between facilities without breaks or delays in the manufacturing process. Not only do existing manufacturing processes have problems with the flow of parts and partially assembled devices between manufacturing facilities, but information flow is also a common problem. The work orders, including the lists of component parts and the labor steps necessary to be performed in assembling the devices, must be generated and timely distributed for the portion of the manufacturing process to be performed at each of potentially numerous manufacturing facilities. Any errors in this phase of the manufacturing process generally result in increased costs and delays in delivering the assembled products, and ultimately can alienate customers through frustration and dissatisfaction.

The manufacturing process additionally includes the generation of product packaging and application of labels for shipping and delivery of the devices. Labels include directions for use and warnings involving the use of the device. Labels are usually different for each device, depending on the individual components and connections that make up the particular devices. Once again, coordination is required between the designers of the devices and the manufacturing personnel to ensure that the labels and packaging are appropriate and accurate for the device. The human interaction and coordination between designers and manufacturers introduces increased costs and further likelihood for human error.

Additional problems and issues arise from existing design and manufacturing processes of multiple component medical devices. For example, in the case of IV sets, a priming volume must often be calculated for each distinct set. The priming volume is the internal volume of the assembled IV set, and is important in ensuring that the medical practitioners administer the correct dosage of medication or other liquid. The first time an IV set is used, the medical practitioner administers medication or other liquid in addition to the prescribed dosage in an amount equal to the priming volume, as this additional liquid remains in the IV set and is not delivered into the bloodstream of the patient. For subsequent uses, the practitioner administers the prescribed amount of liquid since the IV set is already filled with the liquid from previous use.

The priming volume of IV sets may be calculated through experimentation. First, a sample IV set is manufactured. It is then weighed to determine its weight when empty. The sample set is then filling with a liquid and weighed a second time. The difference between the empty weight of the sample and the weight of the sample when filled with the liquid is used to determine the volume of the sample. This method is time consuming and prone to human error. In addition, this method requires a sample set to be constructed prior to determining its priming volume.

Alternatively, the priming volume may be calculated by a manual addition of the individual priming volume of the individual components that make up a particular IV set. As the number of components may be large in complex IV sets, the calculation of the priming volume may become time consuming and is subject to multiple calculation errors. In addition, the calculation of the priming volume is further complicated in that some components overlap, thereby requiring adjustment of the priming volume to account for component overlap. Consider the example in which a particular device includes a piece of tubing of predetermined length that overlaps by ¼ inch at the bond with the component to which it is connected. The volume within the ¼ inch of tubing must be subtracted from the priming volume, otherwise the same volume would be double counted and the priming volume calculation would be inaccurate. As medication can be quite concentrated, even a small inaccuracy in the priming volume calculation has the potential for serious consequences to a patient's health due to administering too much or too little of a prescribed medication.

The sterilization requirements of many medical devices such as IV sets result in additional complexity in the manufacturing and delivery process of these devices. After the medical device has been assembled in the manufacturing process, the device may be sterilized at the manufacturing facility or be shipped to another facility for sterilization. The people manufacturing the device exchange information with those people sterilizing the device. Further, the sterilization parameters themselves must be determined by a person, further increasing the potential for error and adding time to the manufacture of the device. Any delays in the sterilization of the device add further delay to the delivery of the device to the customer.

An additional cause of increased costs of multiple component devices in any industry is the customer service costs. Since, as described above, the time to manufacture a device can be quite lengthy, customers often wish to receive an update on the status of the devices they have ordered but have not yet received. To receive the current status information, customers contact a customer service representative who may have limited access to the current status of an order. For example, the customer service representative may only have information indicating that the order is somewhere in the manufacturing stage. In addition, telephone calls from customers for customer support are routinely put on hold for extended periods of times as companies hire fewer customer service representatives than are needed in an attempt to reduce these additional costs. This further increases customer frustration and dissatisfaction with the particular manufacturer or distributor.

Therefore, as described above, many problems, delays, and inefficiencies are present in the existing systems and methods for designing and manufacturing multiple component devices. These problems make it extremely difficult for manufacturers to meet all the customer requirements and design criteria while keeping costs and production delays to a minimum.

### SUMMARY OF THE INVENTION

One preferred embodiment is a computerized system for designing a multiple component device and generating instructions for manufacturing the multiple component device. The system comprises a data storage device configured to store and retrieve at least one configuration of a multiple component device, the data storage device having stored thereon a first configuration of a first multiple component device. The system also comprises a server in data communication with the data storage device wherein the server comprises a set maker processing module configured to retrieve the first configuration of the first multiple component device from the data storage device, and store a second configuration of a second multiple component device on the data storage device, wherein the second configuration is based at least in part on the first configuration, a document control processing module configured to lock the second configuration from further modification, and a manufacturing work order processing module configured to retrieve the second configuration from the data storage device, and generate instructions from the second configuration for assembling the second multiple component device.

Another preferred embodiment is a computerized method of designing a multiple component device and generating instructions for manufacturing the multiple component device. This method comprises storing on a data storage device a first configuration of a first multiple component device, retrieving the first configuration of the first multiple component device from the data storage device, storing a second configuration of a second multiple component device on the data storage device, wherein the second configuration is based at least in part on the first configuration, locking the second configuration from further modification, retrieving the second configuration from the data storage device, and generating instructions from the second configuration for assembling the second multiple component device.

### BRIEF DESCRIPTION OF THE DRAWINGS

Various features and advantages of embodiments of the present invention will be better understood by referring to the following detailed description. These drawings and the associated description are provided to illustrate certain embodiments of the invention, and not to limit the scope of the invention.

FIG. 1 is a block diagram illustrating an example of a computer system for multiple component device design.

FIG. 2 is a block diagram illustrating examples of components or modules that execute on the main server in certain embodiments of the computer system for multiple component device design shown in FIG. 1.

FIG. 3 is a block diagram illustrating examples of components or modules of the set maker processing module in certain embodiments of the main server shown in FIG. 2.

FIG. 4 is a flowchart illustrating an example of a one page work order process as performed by the one page work order processing module shown in FIG. 2.

FIG. 5 is a flowchart illustrating an example of an electronic tracking process as performed by the electronic tracking processing module shown in FIG. 2.

FIG. 6 is a flowchart illustrating an example of an auto label process as performed by the auto label processing module shown in FIG. 2.

FIG. 7 is a flowchart illustrating an example of a document control process as performed by the document control processing module shown in FIG. 2.

FIG. 8 is a flowchart illustrating an example of a qualification and validation process as performed by the qualification and validation processing module shown in FIG. 3.

FIG. 9 is a flowchart illustrating an example of a process for determining other set information as performed by the determine other set information processing module shown in FIG. 3.

FIG. 10 is a flowchart illustrating an example of an audit process as performed by the audit processing module shown in FIG. 3.

FIG. 11 is an example of a flowchart illustrating a non-sterile sample preparation process as performed by the non-sterile sample preparation processing module shown in FIG. 3.

FIG. 12 is a flowchart illustrating an example of a kit factory preparation process as performed by the kit factory preparation processing module shown in FIG. 3.

FIG. 13 is a flowchart illustrating an example of an assembly preparation process as performed by the assembly preparation processing module shown in FIG. 3.

FIG. 14 is a flowchart illustrating an example of a post-assembly process as performed by the post-assembly processing module shown in FIG. 3.

FIG. 15 is a top-level data flow diagram illustrating an example of the flow of data between various modules, databases and screens of certain embodiments of the computer system for multiple component device design and associated modules shown in FIGS. 1-3.

FIG. 16 is a screen shot illustrating an example of a set maker startup screen.

FIG. 17 is a screen shot illustrating an example of a set maker component information screen.

FIG. 18 is a screen shot illustrating an example of a set maker add component screen.

FIG. 19 is a screen shot illustrating an example of a set maker built set

FIG. 20 is a screen shot illustrating an example of a set maker device screen displaying certain calculations and other information regarding the set.

FIG. 21 is a screen shot illustrating an example of a set maker save screen for saving the set configuration data.

FIG. 22 is a screen shot illustrating an example of a set maker find screen for searching and finding previously saved set configuration data.

FIG. 23 is a screen shot illustrating an example of a set maker configuration data screen for displaying certain data regarding a saved set configuration.

FIG. 24 is a screen shot illustrating an example of a non-sterile sample work order screen for a saved set configuration.

FIG. 25 is a screen shot illustrating an example of a one-page work order screen for a saved set configuration.

FIG. 26 is a screen shot illustrating an example of a product cross reference search screen for locating products or components that are substantially equivalent or interchangeable with a competitor's products or components.

FIG. 27 is a screen shot illustrating an example of several cross reference results screens for displaying product cross-reference information resulting from a cross reference search as in FIG. 26.

FIG. 28 is an example of a component information portion of a component information screen for displaying various component, connection, and cost information for an IV set and is split into FIGS. 28A and 28B for ease of viewing.

### DETAILED DESCRIPTION OF CERTAIN EMBODIMENTS

The following detailed description is directed to certain specific embodiments of the invention. However, the invention can be embodied in a multitude of different ways as defined and covered by the claims. The scope of the invention is to be determined with reference to the appended claims. In this description, reference is made to the drawings wherein like parts are designated with like numerals throughout.

Introduction

The various embodiments of the computer system for multiple component device design eliminate many of the numerous problems, delays, and inefficiencies that are present in existing systems and methods as described above. In one embodiment, many of the phases of designing and manufacturing multiple component devices are managed, controlled, and coordinated by one or more computer servers. Thus, instead of the device design and manufacturing process being a series of manually performed steps as in existing systems with only limited, if any, computer involvement, the computer system for multiple component device design automates and centralizes a large portion of the process. In addition, the computer system for multiple component device design eliminates redundant data entry and other labor-intensive tasks such as filling out forms and communicating instructions to others involved in the process. The computer system for multiple component device design provides tremendous benefits and advantages, such as a significantly reduced design time resulting in much shorter times between first customer contact to shipment of the devices, the occurrence of dramatically fewer human errors, dramatically streamlined FDA approval process for medical device embodiments, the potential for greatly increased profits through more accurate and reliable pricing calculations, and notably increased customer satisfaction and loyalty as a result of the superior service and quality provided by these copious benefits and advantages.

Although applicable for various types of multiple component devices in various fields, the following description discusses certain embodiments of the invention in the context of medical devices. More specifically, the design and manufacture of intravenous (IV) sets in the medical device field are described below. The following description of medical device embodiments may be applied equally to embodiments involving other types of multiple component devices in other fields.

The computer system for multiple component design is preferably used by the designer, manufacturer, and/or distributor of the various medical devices. The customer may provide the desired specifications and/or functions of the proposed IV set in sufficient detail to allow the manufacturer to design the set. The customer may also provide the quantity that will be ordered. The customer normally requests a price quotation for the specified medical device in the quantity indicated. The system preferably utilizes a computerized graphical design and diagramming program to design the IV set so that the system can generate the parts list and labor tasks involved in manufacturing the device. The graphical design and diagramming program greatly reduces the design time and enables extremely accurate and automated calculations of the cost of producing the device from the automatically generated parts lists and labor tasks.

The graphical design and diagramming program can be a custom application coded by the manufacturer or designer, or a commercially available diagramming application program. If the company utilizes a commercially available program, the program preferably can be customized by the user for maximum flexibility. Customization allows the user to program the application to perform a virtually endless number of user-definable tasks and operations. For example, the user can define stencils that can be dragged and dropped to design the medical devices meeting the customers' specifications. Stencils are essentially a collection of pre-defined components that are available to be incorporated into the design of a particular device.

For example, medical device stencils can include such pre-defined components as connectors, tubing, injection sites, and Y-sites. Certain properties are associated with each component. The designer can simply drag components into the design diagram portion of the computer screen and position them as desired in relation to other components. In addition, the diagramming program can automatically generate a bond between components in the diagram, for example, when a Y-site is dragged and dropped onto an existing piece of tubing. Other advantageous features of the design and diagramming program include clicking on a component to view its properties (e.g., where the component comes from, its price, its dimensions, and its compatibility with other parts), the ability to move components around on the screen while keeping connections with other components that have been defined, and saving the design of a device on a computer storage device such as hard disk drive. In addition to the features listed above, many other features can also be included in the design and diagramming program to further aid the design process of the multiple component devices.

The design of new IV sets can be accomplished in a significantly shorter time using the computer system for multiple component device design as described above. However, the ability to save device designs on a computer storage device for future use offers tremendous potential for an even greater saving of time. Many customers inquire about ordering IV sets that are similar to sets they have previously ordered and used. The new IV set the customer seeks to order may differ in just a few components from a previous set. In this case, the employee of the manufacturer or distributor can quickly search through saved set designs, open a saved design that is similar to or the same as a new design, make the few requested changes (if any), and save the new design as a new configuration file. As the number of saved set designs becomes very large, most new sets do not have to be designed from the beginning each time. This dramatically reduces the design time for new IV sets by a substantial amount, thereby reducing design cost and at the same time greatly increasing overall customer satisfaction. In addition, a manufacturer or distributor can significantly reduce labor overhead costs for designing IV sets, as a small fraction of the number of employees are able to design the same number of devices that previously required a much greater number of employees.

Many additional benefits and advantages are also realized. For example, IV sets must undergo a rigorous qualification and validation process for FDA approval, which is traditionally a slow and expensive process taking several weeks to a month, or more. However, once the employee completes the design of a new IV set with the computer system for multiple component device design, the system evaluates whether the new device meets FDA qualifications by comparing it to existing saved device configurations that have already been FDA approved. Often, the system can determine FDA approval of new medical devices without any additional qualification and validation testing, resulting in a tremendous additional time and cost savings.

In addition, the computer system for multiple component device design calculates cost/pricing information automatically for a given medical device design. Each component in the IV set has associated cost information. The system also automatically determines the appropriate type of bond that is required to connect the components together in building the set. Still further, the system determines the labor tasks required in assembling the IV set, and calculates the labor costs by taking into account the corresponding labor rates. The system can determine the most advantageous location(s) for assembly of the IV set by considering the labor rates and costs at the various manufacturing locations that are available to assemble the set. Thus, once the design of the set is entered into the design and diagramming program, the system can calculate the total cost to produce the set by adding all the component costs, bond costs, and associated labor costs. The system can determine the total manufacturing costs, including any shipping or other miscellaneous fixed costs, and provide a price quote essentially instantaneously to the customer. Typically, the employee can rapidly provide the price quote to the customer, for instance while the customer is still on the telephone for the initial inquiry. This rapid response to requests for price quotations is believed to increase the number of orders actually placed by customers.

The rapid price quotation feature of the computer system for multiple component device design also allows the designer to quickly select the most cost effective design from many potential designs that meet the functional requirements of the IV set. For example, the designer, and/or the computer software, can quickly and easily try various alternative designs that may incorporate one or more components not included in other designs. By utilizing the almost instantaneous price quotation for the set as designed, the designer is able to quickly choose the design that minimizes cost while still meeting the requirements specified for the set. This feature of the system greatly aids the designer in arriving at the final, optimal, yet lowest cost design of the desired IV set. This feature additionally enables the manufacturer or distributor to outbid competitors in a very rapid timeframe, while also ensuring that the price quotation given is accurate and reliable so that the desired profit margin is consistently attained.

A further significant advantage of the computer system for multiple component device design involves automatically calculating physical parameters of the component set, such as the priming volume and length of a medical device. An accurate calculation of priming volume is extremely important, as any inaccuracy could cause administering incorrect initial dosages of medication and may result in injury to the patient. Each component making up an IV set has an associated priming volume that represents the maximum volume of standing fluid that can be held within a particular component. This information is stored, for example, on a computer storage device such as a computer database. An Oracle database is one example of a commercially available database that can be used, although there are many others. In addition, any overlap in components or tubing must be accounted for, so that the priming volume can be adjusted to eliminate any double counting. Once the design for an IV set is entered into the design and diagramming program, the system preferably automatically calculates the priming volume for the entire set, taking into account the above-listed factors. The system calculates the priming volume significantly more accurately than required by the FDA or provided by competitors, and also more accurately than required by most customers. In a similar fashion, the system also calculates the overall length of the IV set to determine the amount of tubing that will be required, the size of the set as designed, and the ease of use of the set. Also, the risk of human error is minimized.

The computer system for multiple component device design also preferably provides cross reference information regarding competitors' products or components. Customers are often familiar with competitors' components that are present in IV sets they have previously ordered, and are not familiar with equivalent components of other manufacturers or distributors. By providing access to information about competitors' products or components that are functionally equivalent or interchangeable products or components, the system enables the designer to easily incorporate the manufacturer's own components into the desired IV set. This allows rapidly substituting for the competitor's components and providing the corresponding price quotation to the customer without any significant delay, resulting in an increased likelihood that the customer will place the order.

Once the customer agrees to the quoted price and places an order for a certain quantity of the desired IV sets, the system initiates the manufacturing process by generating a manufacturing work order. Often the customer places the order in the same phone call as the initial inquiry. An example of a manufacturing work order includes a bill of materials listing the components required and the labor steps involved in assembling the IV set. The system generates the manufacturing work order very rapidly and accurately from the device configuration as entered into the design and diagramming system and from data stored on a computer storage device such as a computer database. More accurate work orders greatly reduce manufacturing mistakes and the associated loss of time and money.

The computer system for multiple component device design also preferably lowers the cost of purchasing components and inventory management by reducing the amount of inventory that the manufacturer needs to maintain. The system, through the bill of materials listing the components required in the manufacturing work orders, generates the information required to schedule the delivery of components very near to the time that the components are assembled into the IV set. For example, component delivery can be scheduled on a daily basis, or even multiple deliveries in a day, depending on the manufacturing schedule and bill of materials generated by the system. This advantageous feature lowers inventory requirements, thereby lowering manufacturing costs and ultimately increasing profits and/or lowering the price that must be charged for the set.

The computer system for multiple component device design can transfer the manufacturing work order information to multiple facilities, thereby ensuring accuracy in the information as it is generated from a common source. For example, the design facility can be at a separate location than the manufacturing facility, which can be located in another place or country with lower labor costs. In addition, the manufacturing process can be split between multiple locations. In the case of medical devices, the IV set can be shipped to a sterilization facility after the manufacturing process is complete. The system manages and tracks orders and ensures a smooth and accurate information flow between the various facilities without breaks or delays in the manufacturing and delivery process. Preferably, the system generates and timely distributes work orders from a common origin, for example, a central computer database, for the portion of the manufacturing process to be performed at each of potentially numerous manufacturing facilities. The manufacturing work orders can include the lists of component parts and the labor steps necessary to be performed in assembling the IV sets. The system dramatically reduces or even eliminates errors in this phase of the manufacturing process, resulting in decreased costs and shorter delivery times for the assembled sets.

Additionally, the computer system for multiple component device design can generate product packaging and labels for shipping and delivery of the medical devices. Labels include directions for use and warnings involving the use of the particular IV set. Labels are usually different for each set, and depend on the individual components and connections that make up the particular sets. Accuracy of the labels may help to ensure proper use of the IV set. Once again, the system accurately transfers accurate labeling information between the designers of the IV sets and the manufacturing personnel to ensure that the labels and packaging are appropriate and accurate for the device.

The computer system for multiple component device design can also preferably reduce customer service costs by providing customers with computerized access to stored up-to-date status information regarding an existing order. The information regarding the multiple phases or stages of design and manufacturing is preferably maintained and stored at a centralized location, and hence the system can provide that information at the customer's request without requiring any additional customer service support. The system also facilitates initiating a trace of an existing order, since the current location of the device is preferably readily available on a storage device connected to the system, for example, a computer database on a hard disk drive. Status information of an order can include the current manufacturing phase of the order, the location of the manufacturing facility producing the order, whether the order is in transit between several facilities, or whether the order has been shipped to the customer. The system can restrict access to its computers to authorized persons by issuing and maintaining usernames and/or passwords for various customers, enabling the customer to log in to the system and access the status information relating to that particular customer's products stored on the system. The system can be made available over a global public network, such as the Internet, so the system can provide status updates to the customer anywhere the customer has access to the network. For example, this access can be via a conventional wired connection, a wireless connection, or satellite network access. Since numerous customer status inquiries can be resolved in this manner, manufacturers and distributors can employ many fewer customer service representatives, thereby reducing the cost of producing the medical devices and likely increasing profits.

The computer system for multiple component device design also preferably provides the capability for the customer to enter information regarding the desired medical device directly into the data storage device of the system rather than relaying the information verbally to an employee. From this information, the designer of the IV set can begin and often complete the design without directly speaking with the customer. Indeed, the customer may perform many, or all, of the functions typically performed by an employee using the system. This feature saves additional time and cost in interacting with the customer in the design phase of the set. The customer can alternatively send the design information for a desired IV set via facsimile transmission, which can be automatically optically recognized or keyed into the system for subsequent use by the designer in creating the IV set design.

As described above, the graphical design and diagramming program can be a custom application coded by the manufacturer or designer, or a commercially available diagramming application program. If the system utilizes a commercially available program, the program preferably can be customized by the user. One such commercially available program that could be used is Visio from the Microsoft Corporation. Visio allows customization through instructions or procedures provided by the user. The instructions or procedures can be written in the Visual Basic language, the Visual C language, or the Visual C++ language, to name just a few. Visio allows user-programmed procedures or modules to be executed upon the occurrence of certain events. In this way, the user can customize the application to perform a virtually endless number of user-definable tasks and operations, and can modify the user-programmed procedures as the system requirements may change or bugs are detected and fixed. While the embodiments described herein utilize the Visio application, many other custom or commercial applications could also be used having some of the same features and capabilities as Visio.

Visio includes stencils that can be dragged and dropped to design the devices meeting the customers' specifications. Stencils in Visio and other design and diagramming applications are essentially a collection of pre-defined components that are available to be incorporated into the design of a particular device. For example, medical device stencils can be made to include such pre-defined components as connectors, tubing, injection sites, and Y-sites, having properties associated with each component. The designer can drag components into the design diagram portion of the computer screen and position them as desired in relation to other components. Many features are programmed into the design and diagramming program to facilitate the design process. As one example associated with medical device design, a bond can be automatically generated in the diagram when a Y-site is dragged and dropped onto an existing piece of tubing. Other advantageous features of the design and diagramming program include clicking on a component to view its properties (e.g., the manufacturer of the component, its price, its dimensions, and its compatibility with other parts), the ability to move components around on the screen while keeping connections with other components that have been defined, and saving the design of a device on a computer storage device such as hard disk drive. In addition to the features listed above, many other features can also be included in the design and diagramming program to further aid the design process of the multiple component devices.

Therefore, as described above, the systems and methods described herein address and solve the numerous delays, inefficiencies, and sources of errors present in the existing systems for designing and manufacturing multiple component devices, for example, medical devices such as IV sets. Certain embodiments of the computer system for multiple component device design eliminate redundant data entry and form filling, greatly reduce the time for device design and FDA approval of medical devices, efficiently and accurately communicate instructions to all facilities and personnel involved in the entire design and manufacturing processes, provide up-to-date status information, and automate many of the tasks that are manually performed in existing systems.

The computer system for multiple component device design described herein can be implemented in different embodiments as various modules. The components or modules can be implemented as, but are not limited to, software, hardware, or firmware components, or any combination of such components, that perform certain functions, steps, or tasks as described herein. Thus, for example, a component or module may include software components, firmware, microcode, circuitry, an application specific integrated circuit (ASIC), and may further include data, databases, data structures, tables, arrays, and variables. In the case of a software embodiment, each of the modules can be separately compiled and linked into a single executable program, or may be run in an interpretive manner, such as a macro. The functions, steps, or tasks associated with each of the modules may be redistributed to one or more of the other modules, combined together in a single module, or made available in, for example, a shareable dynamic link library. Furthermore, the functionality provided for in the components or modules may be combined into fewer components, modules, or databases or further separated into additional components, modules, or databases. Additionally, the components or modules may be implemented to execute on one or more computers.

Description of the Figures

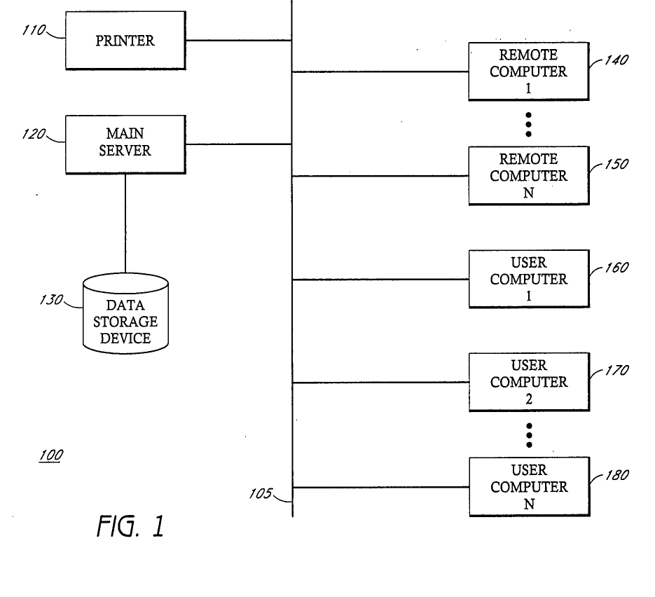

Referring now to the figures, FIG. 1 is a block diagram illustrating one example of a computer system for multiple component device design 100. The computer system for multiple component device design 100 preferably includes a main server 120, on which the components or modules described herein can execute. The main server 120 is a computer system that performs certain tasks of the computer system for multiple component device design 100. In some embodiments, the components or modules execute on a single main server for designing the devices, determining the FDA approval status in the case of medical devices, communicating instructions to the facilities and personnel involved in the design and manufacturing processes, providing up-to-date status information, and performing the numerous other tasks of the computer system for multiple component device design 100 as described above. Alternatively, the components or modules can execute on multiple servers that are in data communication with one another, for example, via a computer network.

The computer system for multiple component device design 100 includes a data storage device 130 in data communication with the main server 120. The main server 120 preferably uses the data storage device 130 for reliable, long term storage of data, for example, saved device configurations, component stencils, component bonding information, device qualification and validation data, work orders, order tracking and status information, and other manufacturing instructions. Although FIG. 1 shows a single data storage device 130, other embodiments can include multiple data storage areas in alternative storage configurations in order to meet particular system requirements. The data storage device 130 can include such long-term memory storage devices as hard disk drives, database management systems, tape drives, or other long-term storage devices and combinations of the foregoing. The data storage device 130 can preferably store one or more computer databases, for example, databases that conform to the structured query language (SQL) database standard. The Oracle database is an example of a commercially available database that can be stored on the data storage device 130.

Additionally, the computer system for multiple component device design 100 preferably includes a remote computer 1 140. The remote computer 1 140 can be one or more computers and associated input devices. The remote computer 1 140 is preferably used by users of the computer system for multiple component device design 100 that are involved in the design, manufacturing, or other production phases of the device. The user can preferably access and use the computer system for multiple component device design 100 by entering commands and viewing device information in a logical and easy to use manner via a graphical user interface (GUI) that executes on the remote computer 1 140. Alternatively, the GUI can execute on the main server 120. One example of the GUI is a web browser program which is a program used to locate and display web pages over the Internet. The remote computer 1140 can also employ other types of user interfaces, such as scripting language files or command line interfaces.

The computer system for multiple component device design 100 also preferably includes a remote computer N 150. As designated by the designation “N” for the remote computer N 150, any number of remote computers can be utilized in the computer system for multiple component device design 100. Alternatively, the computer system for multiple component device design 100 could be configured to include only a single remote computer, or all of its functions could be performed by one computer.

In the preferred embodiment, the remote computer 1 140 and the remote computer N 150 communicate with each other, with the main server 120, and with other devices and computers connected via a communication link 105. The communication link 105 transfers data between the computers and devices of the computer system for multiple component device design 100, and is preferably a high throughput, low latency communication interface link. The communication link 105 can be a commercially available communication link, or a custom-built communication link. Several examples of commercially available communication links include an Ethernet network connection that conforms to the TCP/IP network protocol such as the Internet, a local area network (LAN), a wide area network (WAN), an Intranet, or other network links and protocols.

The computer system for multiple component device design 100 includes a printer 110 that is in data communication with the main server 120 and other computers and devices via the communication link 105. The printer 110 is used to generate, in hardcopy form, such items as forms, screen displays, work orders, and device information descriptions created and maintained by the computer system for multiple component device design 100.

The computer system for multiple component device design 100 can additionally include a user computer 1 160 that is connected to the various devices and computers via the communication link 105. For example, the customers of the computer system for multiple component device design 100 can use the user computer 1 160 to access customer information such as the status of a particular order for devices. The customers can access and use the computer system for multiple component device design 100 via the Internet or other network connection by entering commands and viewing device information in a logical and easy to use manner via a graphical user interface (GUI), for example, a web browser program, that executes on the user computer 1 160 or on the main server 120. The user computer 1 160 can also employ other types of user interfaces, such as scripting language files or command line interfaces.

The computer system for multiple component device design 100 can also include additional user computers, as shown by a user computer 2 170 and a user computer N 180, that are connected to the other devices and computers via the communication link 105. As designated by the designation “N” for the user computer N 180, any number of user computers can be utilized in the computer system for multiple component device design 100. Alternatively, the computer system for multiple component device design 100 can include only a single user computer.

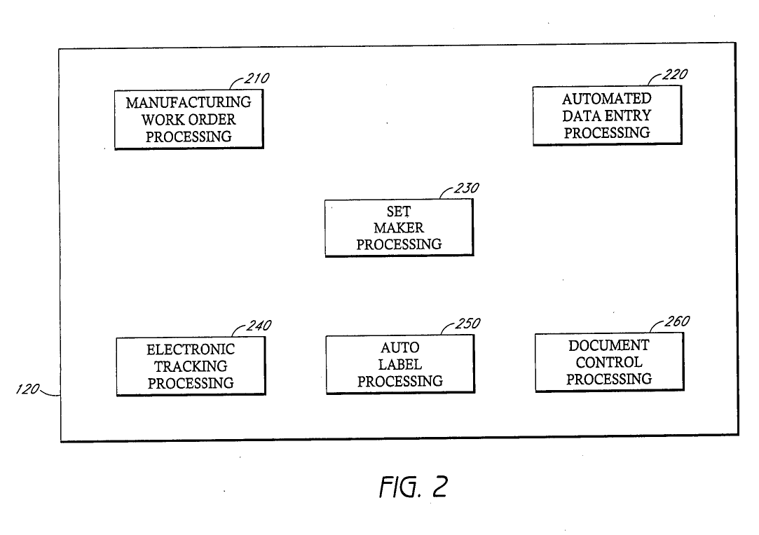

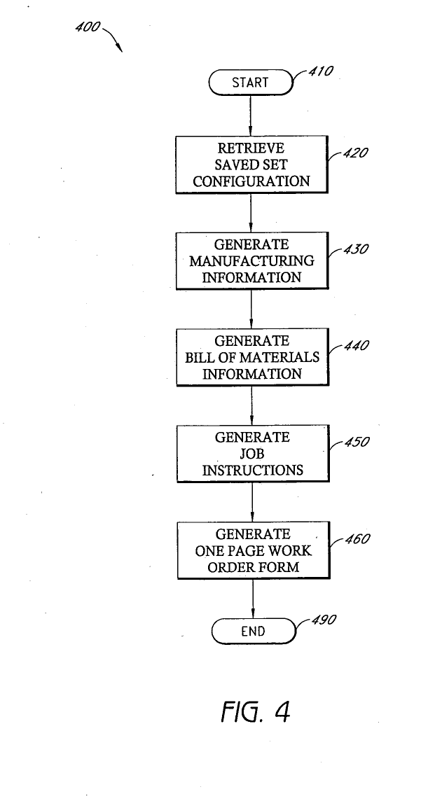

FIG. 2 is a block diagram illustrating components or modules that execute on the main server 120 in certain embodiments of the computer system for multiple component device design 100 shown in FIG. 1. Many of the functions and modules of the computer system for multiple component device design 100 can execute on the main server 120, including a manufacturing work order processing module 210. The manufacturing work order processing module 210 generates a one-page work order, which can be printed on the printer 110, that includes such information regarding the manufacturing of the assembled component device as the bill of materials, distributor or sales representative information, gross profit for the device, distributor price, the quantity desired, the sales prices, FDA approval information, cross reference information for competitors' products, and shipping and packaging information. The manufacturing work order processing module 210 preferably accesses one or more of the databases of the computer system for multiple component device design 100 to access the data used in generating the one-page work order. The preferred operation of the manufacturing work order processing module 210 is described in greater detail below, including in the flowchart of FIG. 4.

The main server 120 can also include an automated data entry processing module 220. There are several modes of data entry available for entering the data used to design and build a multiple component device. For example, the customer can give the information verbally over the telephone to the designer, who manually enters the information directly into the device design system. Alternatively, the customer can directly enter the information into the device design system by accessing the system remotely, for example, via a public network such as the Internet. Still further, the automated data entry processing module 220 can be structured to automate the manual entry of device information by automatically entering data from a received facsimile document, emailed document, or voicemail message with information for a device.

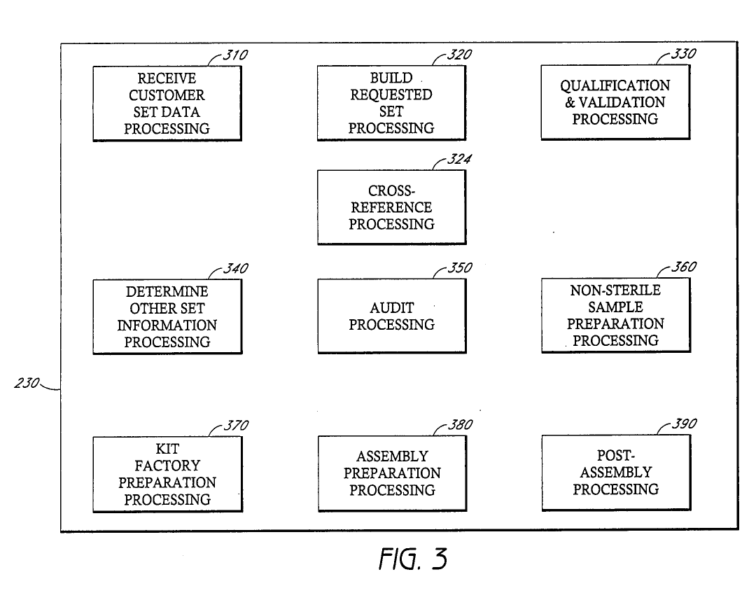

In medical device design embodiments, the main server 120 can also include a set maker processing module 230. The set maker processing module 230 preferably includes a number of modules for designing, qualifying and validating, manufacturing, and auditing an IV set or multiple IV sets. The functions and modules of the set maker processing module 230 enable the very rapid and cost-effective design of IV sets, as well as the manufacturing and related processes. Additionally, since the functions and modules access a common database or set of databases, data entry of related set information is not duplicated among the multiple phases of the design and manufacturing processes. The various functions and modules of the set maker processing module 230 are described in greater detail below, including in FIG. 3 and the related textural description.

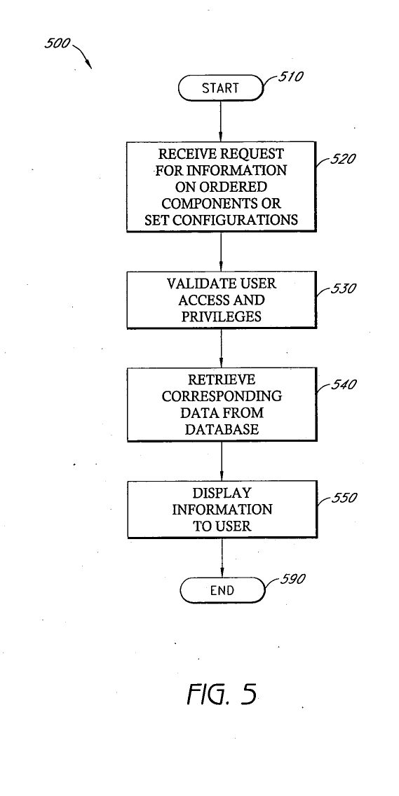

The main server 120 can additionally include an electronic tracking processing module 240 for enabling distributors or customers to view information related to the status of ordered devices. For example, the electronic tracking processing module 240 enables the distributors or customers to access the ordered device information via a public network such as the Internet. The electronic tracking processing module 240 is believed to lower the manufacturer's and/or distributor's customer service costs by allowing the customer to access ordered device information without speaking to a customer service representative. The operation of the electronic tracking processing module 240 is described in greater detail below, including in the flowchart of FIG. 5.

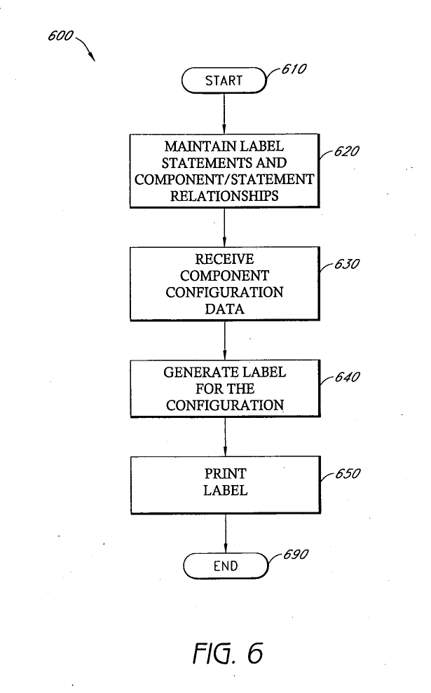

Still further, the main server 120 can include an auto label processing module 250. The auto label processing module 250 generates labels and instructions, for example, Directions For Use (DFUs), warnings and cautions, for the IV sets designed and manufactured using the computer system for multiple component device design 100. The DFUs for a particular IV set are determined by the components that make up the set. DFUs can be very complicated and lengthy for complex sets. Manually generating the DFUs can be a very time-consuming and costly process since each DFU can be unique and thus must be composed and verified individually for each IV set. The auto label processing module 250 greatly speeds up this process by automatically generating the DFU for the IV sets designed and manufactured using the computer system for multiple component device design 100. The operation of the auto label processing module 250 is described in greater detail below, for example, including in the flowchart of FIG. 6.

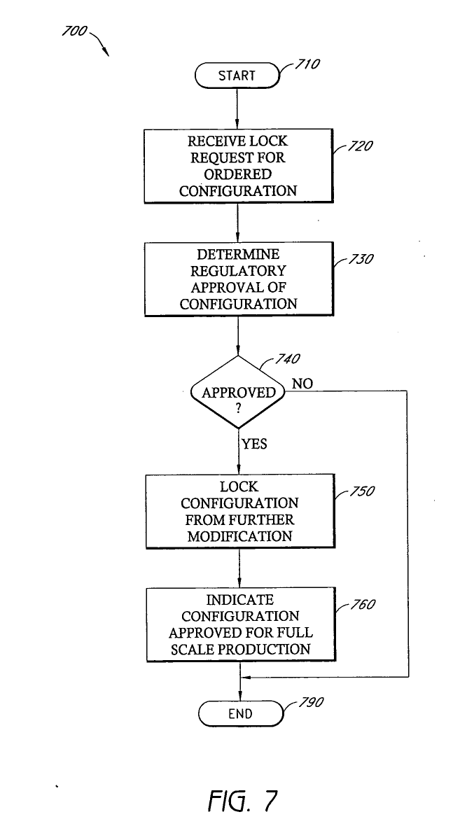

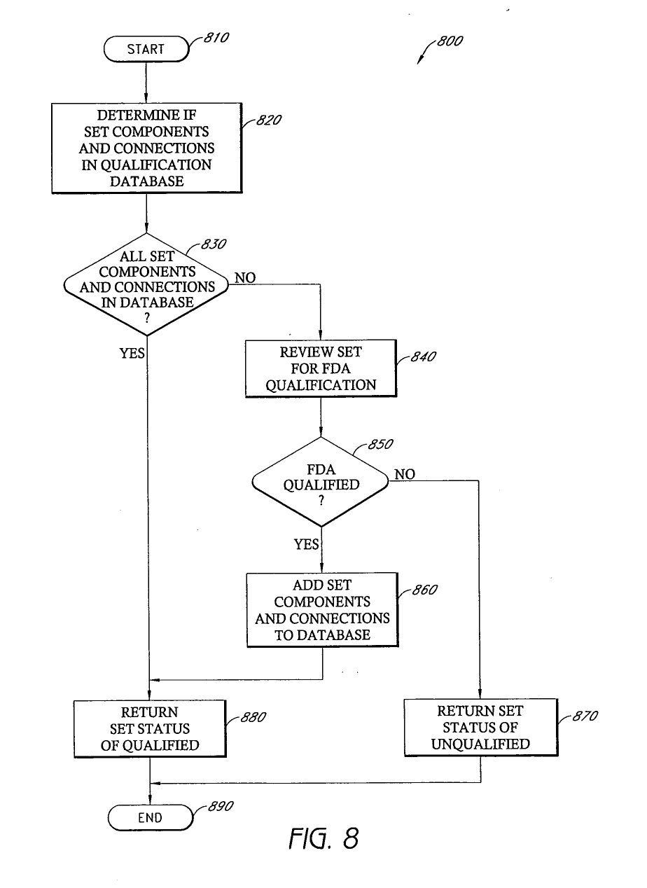

The main server 120 can also include a document control processing module 260. The document control processing module 260 preferably maintains integrity in, and configuration control of, the various files and data associated with the design and manufacturing of a device by restricting or preventing changes to the files and data once the design is complete and the customer approves of the design. In the case of medical devices, during the FDA approval process and after approval of the set, the configuration of the set design cannot be changed. Thus, during these stages of production, the document control processing module 260 preferably locks the files and data from any further change. The document control processing module 260 preferably ensures that the configuration of the device as designed and FDA approved is the same configuration that is manufactured, tested, and delivered to the customer. The operation of the document control processing module 260 is described in greater detail below, including in the flowchart of FIG. 7.

FIG. 3 is a block diagram illustrating components or modules of the set maker processing module 230 in certain embodiments of the main server 120 shown in FIG. 2. The components or modules of the set maker processing module 230 preferably perform a portion of the functionality of the computer system for multiple component device design 100. Alternatively, the components or modules of the set maker processing module 230 shown in FIG. 3 can be executed in other modules or on computer systems other than the main server 120. Various functions of computer systems can be shifted among multiple modules, and modules can be shifted among multiple computer systems.

The set maker processing module 230 shown in FIG. 3 includes a receive customer set data processing module 310 for receiving the information needed to design and manufacture the multiple component IV set as specified by the customer or distributor. As described above, the customer can communicate the information to the designer over the telephone, the customer can directly enter the information by accessing the computer system for multiple component device design 100 over a public network such as the Internet, or the automated data entry processing module 220 can automate the data entry by scanning incoming facsimile documents. In addition, other methods of receiving and entering information from the customer to design and manufacture devices are also viable including receiving and automatically or manually processing email, voicemail, or telephonic information.

The set maker processing module 230 also preferably includes a build requested set processing module 320 for entering into the system the design of the IV set as specified by the customer. In some embodiments, the build requested set processing module 320 utilizes a computerized graphical design and diagramming program. The graphical design and diagramming program greatly reduces the design time for the IV set, and enables accurate and automated calculations of the cost of producing the set from the parts lists and labor tasks, which can be automatically generated.

The graphical design and diagramming program can be a custom application implemented by the manufacturer or designer, or a commercially available diagramming application program. If the system utilizes a commercially available program, the program can be customized by the user. One such commercially available program that can be used is Visio from the Microsoft Corporation. Visio allows customization through instructions or procedures provided by the user. The instructions or procedures can be written in various programming languages, such as Visual Basic, Visual C, or Visual C++. While the embodiments are described herein in the context of the Visio application, other custom or commercial applications can also be used having some of the same features and capabilities as Visio, as well as additional features and capabilities.

In the case where the build requested set processing module 320 utilizes the Visio application, Visio includes stencils to design the IV sets meeting the customers' specifications. For example, medical device stencils can include such pre-defined components as luers, tubing, injection sites, and Y-sites, the pre-defined components having properties associated with each component. Certain features relating to the particular components at issue can be built into the design system. For example, in the design of a medical device such as an IV set, a bond can be automatically generated in the diagram when a Y-site is dragged and dropped onto an existing piece of tubing. Other advantageous features of the design and diagramming program include the ability to click on (select) a component to view its properties (for example, where the component comes from, its price, its dimensions, and its compatibility with other parts), the ability to move components around on the screen while keeping already-defined connections with other components, and the ability to save the design of a device on a computer storage device such as hard disk drive. In addition to the features listed above, many other features can also be included in the design and diagramming program to further aid the design process of the multiple component devices.

The set maker processing module 230 preferably also includes a qualification and validation processing module 330. Many devices undergo qualification and validation processes, for example, to meet governmental agency regulations, trade association standards, or internal company qualification standards. In the case of the design and production of medical devices, one example of qualification and validation approval is FDA approval. The operation of the qualification and validation processing module 330 is described in greater detail below, including in the flowchart of FIG. 8.

Still further, the set maker processing module 230 preferably includes a cross-reference processing module 324 for readily accessing information about the manufacturer's own components that are comparable with competitors' components. Customers who inquire about the purchase of multiple component IV sets may inquire about competitors' products or components with which they are familiar or have used in the past, or request that a component be included in the desired set. Also, by providing access to information about competitors' products, the system enables the designer to easily identify the manufacturer's own components for incorporation into the desired set design. This allows rapidly substituting for the competitor's components and providing the corresponding price quotation to the customer rapidly, resulting in an increased likelihood that the customer will place the order with the manufacturer or distributor utilizing the components produced by the manufacturer or distributor.

In some embodiments, the cross-reference processing module 324 produces the component or device cross reference data by utilizing a database stored on the data storage device 130 shown in FIG. 1. For example, the database record for each component or device of the manufacturer or distributor can be structured to include a field or fields for indicating interchangeable components or devices of one or more competitors. Alternatively, the database can include records for each competitor's component or device that includes a field or fields for indicating interchangeable components or devices of the manufacturer. In other words, the database access for the competitor's components or devices can be a forward look up (querying directly for the competitor's products) or a reverse look up (querying for the manufacturer's products and checking if it corresponds to the competitor's product(s) of interest).

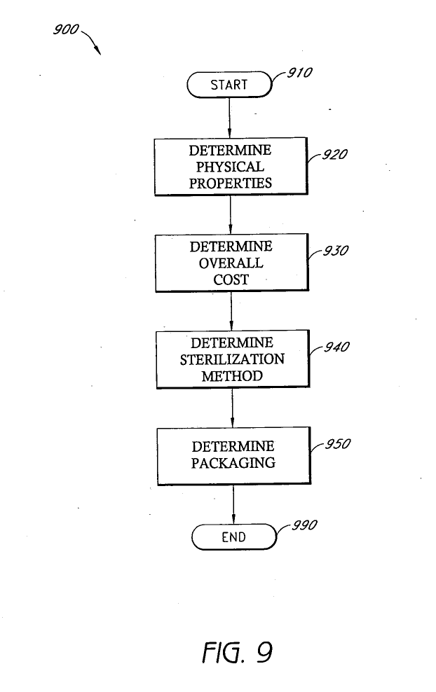

The set maker processing module 230 also preferably includes a determine other set information processing module 340. The determine other set information processing module 340 determines other information relating to a set or device once the design has been entered. For example, the determine other set information processing module 340 can determine such physical property information as the overall length of the set or individual components, or the priming volume of the IV sets. In addition, the determine other set information processing module 340 also preferably determines the overall cost of the device based on the components that make up the device design, determines the sterilization method to be used in sterilizing the device, and determines the packaging in which the device or devices are to be shipped to the customer. The operation of the determine other set information processing module 340 is described in greater detail below, including in the flowchart of FIG. 9.

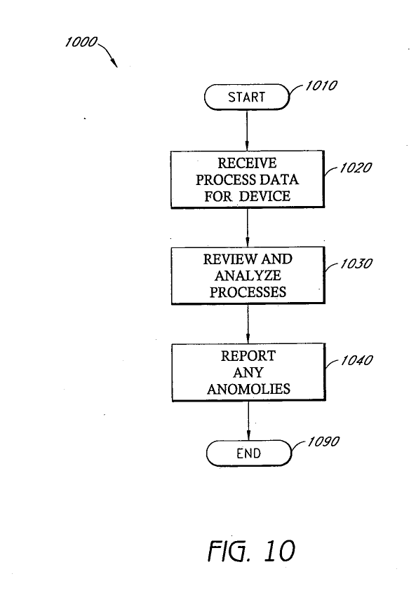

In addition, the set maker processing module 230 preferably includes an audit processing module 350. The audit processing module 350 preferably reviews the design, manufacturing, FDA qualification and validation, sterilization, and delivery processes for any deviations from the proper or preferred procedures, or from required procedures as mandated by any governmental regulatory agencies. The audit processing module 350 is capable of reviewing the entire design and manufacturing process quickly and accurately, and noting any anomalies or items for further review or investigation. The operation of the audit processing module 350 is described in greater detail below, including in the flowchart of FIG. 10.

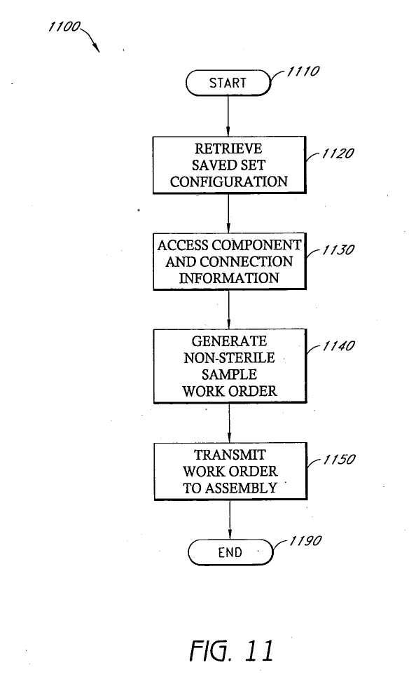

The set maker processing module 230 also preferably includes a non-sterile sample preparation processing module 360. In the medical device industry, customers may request at least one sample of the designed multiple component device prior to full scale production to insure the device as designed meets their needs. Since the sample is for review or analysis purposes and is not put into actual use with a patient, sterilization of the sample device is not required or desired as it would result in an increase in the overall cost and time delay of producing the sample device. The non-sterile sample preparation processing module 360 preferably generates a non-sterile sample work order, which includes the parts list and assembly instructions, and transmits the work order to the assembly facility. The operation of the non-sterile sample preparation processing module 360 is described in greater detail below, including in the flowchart of FIG. 11.

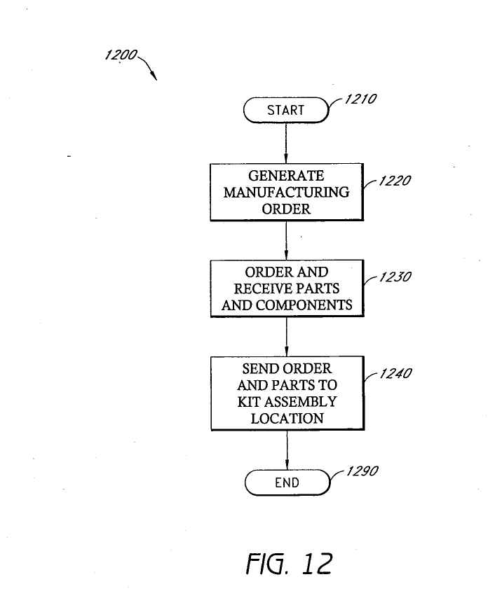

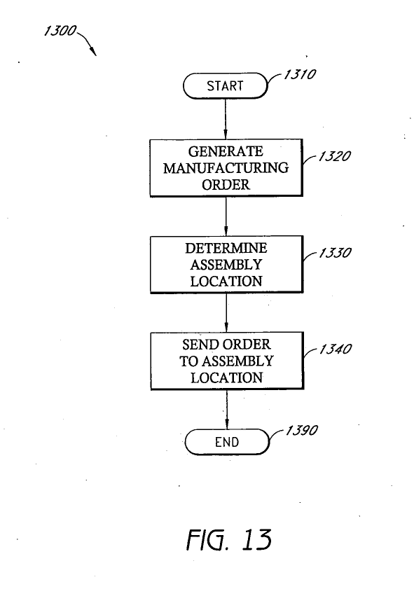

The set maker processing module 230 also preferably includes a kit factory preparation processing module 370. The kit factory preparation processing module 370 preferably receives manufacturing orders, receives component parts, and sends the manufacturing orders and corresponding component parts to the assembly location. In some embodiments, the operations of the kit factory preparation processing module 370 are performed at a separate facility referred to as a kit factory. Alternatively, the first two operations (receiving manufacturing orders and component parts) can be performed at the assembly location. In such an embodiment, the operation of sending the manufacturing orders and component parts to the assembly location is not performed. The operation of the kit factory preparation processing module 370 is described in greater detail below, including in the flowchart of FIG. 12.

The set maker processing module 230 also preferably includes an assembly preparation processing module 380. The assembly preparation processing module 380 sends assembly information for the multiple component IV set to the assembly location. This information can include the list of component parts, with part numbers, to compose the completed set, the labor steps involved in the assembly of the set, and the desired date for shipping the completed set to the customer. The operation of the assembly preparation processing module 380 is described in greater detail below, including in the flowchart of FIG. 13.

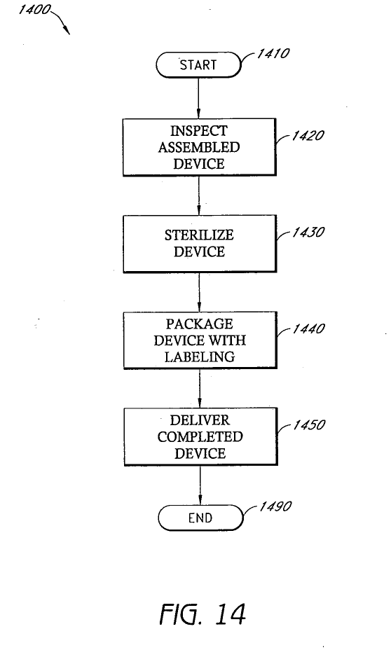

The set maker processing module 230 also preferably includes a post-assembly processing module 390. The post-assembly processing module 390 preferably performs a series of operations after assembly of the IV set but prior to and including shipping the completed set to the customer. For example, the operations performed by the post-assembly processing module 390 may include the sterilization of the device in the case of medical devices, and packaging and delivery of the completed device. The operation of the post-assembly processing module 390 is described in greater detail below, including in the flowchart of FIG. 14.

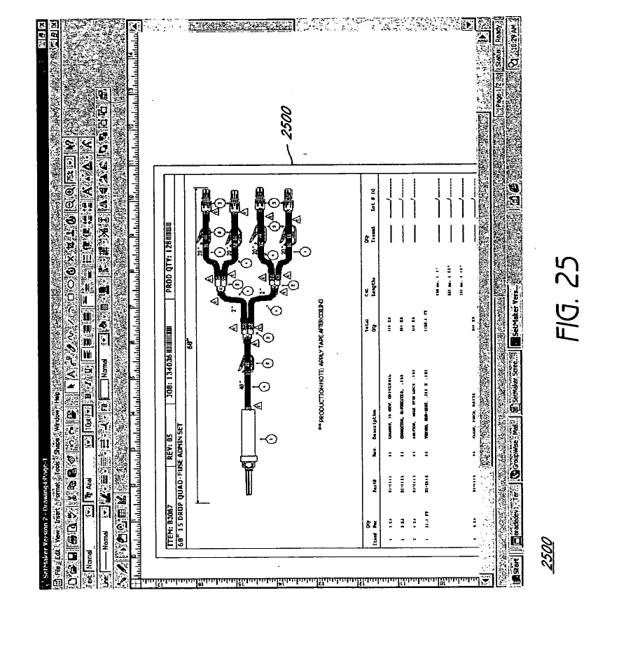

FIG. 4 is a flowchart illustrating a manufacturing work order process 400 as preferably performed by the manufacturing work order processing module 210 shown in FIG. 2. The manufacturing work order process 400 can include generation of a one-page work order form, which can be printed on the printer 110. The one-page work order form can include such information for the medical set as the bill of materials, distributor or sales representative information, gross profit for the set, distributor price, the quantity desired, the sales prices, FDA approval information, cross reference information for competitors' products, and shipping and packaging information. The one-page work order form can include a schematic diagram of the IV set to be manufactured, a detailed parts list for the set, and a list of the labor activities involved in manufacturing the set. In some embodiments, the one-page work order form includes all the information needed by a manufacturer to rapidly assemble the set. Alternatively, other forms could be generated that utilize a different format and include more or less information than described herein. An example of a sample one-page work order form is illustrated in FIG. 25 and described below.

The manufacturing work order process 400 preferably begins at a start block 410. The manufacturing work order process 400 preferably continues to a block 420 for retrieving configuration information of a medical set design that the set maker processing module 230 has saved on the data storage device 130 (see FIG. 1) for future retrieval and revision. The configuration data for a device includes data that describes the design of the device, for example, the physical layout of the device including the components making up the device and connections between components, detailed component information, labor activities involved in assembling the device, cost information including the components and labor, a textual description of the device, a configuration number, and quote information. For example, the manufacturing work order process 400 can retrieve a saved device configuration by reference to the file name of the configuration, or by a search of one or more of various configuration attributes. The configuration attributes available for searching can include name and revision, manufacturer, product cross-reference, modification date or time, length, priming volume, one or more constituent components, associated quotes, or description keywords.

At a block 430, the manufacturing work order processing module 210 preferably generates manufacturing information for sending to the manufacturing location in the one-page work order form. The manufacturing information can include such information as the product name for the IV set, a textual description of the set, a job number, and a quantity to manufacture.

The manufacturing work order process 400 preferably continues to a block 440 for generating bill of materials information for the IV set as performed by the manufacturing work order processing module 210. The one-page work order form can include a bill of materials for the set. The bill of materials is a list specifying the quantity and character of materials and parts required to produce or assemble a certain quantity of the particular device. The bill of materials can include a listing of each raw material used, its part number and revision designation, the quantity per unit, the total quantity ordered, and/or tube cutting instructions for the IV sets. The manufacturing work order processing module 210 preferably generates the bill of materials from the stored set configuration information that was retrieved at the block 420.

The manufacturing work order process 400 preferably continues to a block 450 at which the manufacturing work order processing module 210 generates job instructions for the labor tasks involved in assembling the particular IV set. The job instructions list the labor tasks, and each task includes, for example, a textual description of the labor task, the time allotted for the task, the cost of the task, and the component parts used in the task. The job instructions can identify work centers used during production, their sequence, and any procedures that guide the labor activities at the work center. The job instructions can be used by the personnel at the manufacturing facility as a step-by-step guide in assembling the particular device.

At a block 460, the manufacturing work order processing module 210 preferably generates the one-page work order form from the information generated at the blocks 430, 440, and 450 described above. The one-page work order form includes manufacturing information, a bill of materials, and job instructions for assembling the particular device. The one-page work order form can additionally include a place for recording quality control inspection results and unit accountability information. The information in the one-page work order form could be formatted in many different ways and could include more or less information than that described in regard to FIG. 4. In addition, while the one-page work order form is advantageous because it is very convenient and easy to read and understand, other embodiments of the manufacturing work order processing module 210 can generate manufacturing work order forms that are more than one-page in length. The one-page work order process 400 ends at a block 490.

FIG. 5 is an example of a flowchart illustrating an electronic tracking process 500 as performed by the electronic tracking processing module 240 shown in FIG. 2. The electronic tracking processing module 240 preferably enables the user or customer to easily and quickly access up-to-date status information on ordered IV sets without speaking to a customer service representative. In this way, most customer questions or inquiries can be answered by making the requested data available to the customer without direct human contact.

The electronic tracking process 500 preferably begins at a start block 510. The electronic tracking process 500 continues to a block 520 at which the electronic tracking processing module 240 receives a request for information on ordered components or set configurations. In some embodiments, the request for information can be initiated by a customer at the user computer 1 160 or the remote computer 1 140, which are connected to the main server 120 of the computer system for multiple component device design 100 via the network 105, which can be a public network such as the Internet. Thus, the customer is preferably allowed to access the status information for ordered sets by using a web browser program on a computer that has access to the Internet.

At a block 530, the electronic tracking processing module 240 preferably validates user access and privileges. Since it is possible for different users to have different levels of access to certain information, the electronic tracking processing module 240 preferably prompts the user for individual identification data, which can include a user name and password combination that is unique to each user. In this way, a user who is a distributor may have access to more information than a user who is a customer. Likewise, a user who is a device designer may have access to more information than a distributor. Having identified and validated the user, the electronic tracking processing module 240 determines the level of access to certain information, as well as the system privileges that are associated with the particular user.

The electronic tracking processing module 240 preferably continues to a block 540 for retrieving the data from the database on the data storage device 130 associated with the request for information received at the block 520. Depending on the request, the electronic tracking processing module 240 can preferably retrieve database infomnation from one or more records or tables in the database. Having retrieved the information, the electronic tracking processing module 240 displays the information to the user at a block 550, for example, via a web browser program on a computer with access to the Internet. The electronic tracking process 500 ends at a block 590.

FIG. 6 is a flowchart illustrating an auto label process 600 as performed by the auto label processing module 250 shown in FIG. 2. Manufacturers of medical devices may be required to provide customers with adequate instructions for using the products they sell in order to comply with FDA regulations. The auto label processing module 250 preferably automatically generates directions for use (DFUs), cautions and warnings in the form of labels and instructions for each medical device designed and manufactured by the computer system for multiple component device design 100. The DFUs are based on instructions associated with and/or stored with the device configuration for each component making up the particular device. The DFUs can be configured to be different for each different IV set manufactured, depending on the particular feature of an assembled component device.

The auto label process 600 begins at a start block 610. The auto label process 600 preferably continues to a block 620 at which the auto label processing module 250 maintains label statements for each component that can be used in a device, and maintains the relationship between the components and the corresponding statements that can be incorporated into the labels. In some embodiments, the auto label processing module 250 stores statements for inclusion in the DFUs in the data storage device 130, and assigns a priority to the statements such that the statements with the lowest priorities are displayed before those with higher priorities, for example. Statements may include DFUs, cautions or warnings to prevent accidental misuse or mistakes, patent numbers associated with each component or a combination of components, and miscellaneous statements that provide any additional information or declarations about a component or product.

At a block 630, the auto label processing module 250 preferably receives component configuration data for the IV set to be labeled. The component configuration data includes information specifying the individual components of the particular set. The auto label process 600 continues to a block 640 at which the auto label processing module 250 generates the label for the set configuration. Using the label statements and component/statement relationships maintained at the block 620, the auto label processing module 250 accesses the various statements for the components making up the particular set to include in the label.

The auto label process 600 preferably continues to a block 650 at which the auto label processing module 250 prints the label that was generated at the block 640 for the IV set. For example, the auto label processing module 250 can print the label on the printer 110 shown in FIG. 1, or on another printer connected to the network 105 or directly connected to the main server 120. The auto label process 600 preferably ends at a block 690.

FIG. 7 is a flowchart illustrating a document control process 700 as preferably performed by the document control processing module 260 shown in FIG. 2. The document control processing module 260 preferably maintains integrity and configuration control in the various files and data associated with a device configuration by restricting or preventing changes to the configuration once the design is complete and the customer approves of the design. This ensures that the device as manufactured is the same as the device as designed and the document control processing module 260 locks the configuration from any further change during and after the FDA approval inquiry process. The document control processing module 260 ensures that the configuration of the medical device as designed and FDA approved is the same configuration.

The document control process 700 preferably begins at a start block 710. The document control process 700 continues to a block 720 where the document control processing module 260 receives a request to lock a particular device configuration of an IV set that has been approved by the customer. At a block 730, the document control processing module 260 determines whether the IV set as designed satisfies regulatory agency approval requirements such as FDA approval. The document control processing module 260 accesses the database for the components that make up the set to determine the FDA approval status of each component, and to determine whether the combinations of components meet FDA approval as connected in the set. At a decision block 740, the document control processing module 260 checks whether the device as designed meets FDA approval.

If the device meets FDA approval at the decision block 740, the document control processing module 260 preferably locks the device configuration from further modification at a block 750. In some embodiments, the lock can be implemented by setting a location in memory to a value indicating the locked status. For the duration of the locked status, no further modifications to the set configuration are permitted. This configuration control feature ensures that the device undergoing full scale production meets FDA approval as designed and prevents subsequent changes not meeting FDA approval. For the case where the device meets FDA approval, the document control processing module 260 marks the device as approved for full scale production, for example, by indicating in the configuration data by setting a location of memory associated with the device configuration to a value indicating approval for full scale production. If the device is not approved for full scale production at the decision block 740 or after the block 760, the document control process 700 ends at a block 790.

FIG. 8 is a flowchart illustrating a qualification and validation process 800 as performed by the qualification and validation processing module 330 shown in FIG. 3. Medical devices are subject to FDA qualification and validation prior to being used on a patient. The qualification and validation processing module 330 is configured to rapidly determine whether a newly-designed IV set meets FDA approval requirements by comparing the new set to one or more previous saved sets that have already satisfied FDA approval requirements.

The qualification and validation process 800 preferably begins at a start block 810. The qualification and validation process 800 continues to a block 820 at which the qualification and validation processing module 330 determines if components and connections of the newly designed set are stored in the qualification database as a previously designed and FDA approved set. At a decision block 830, if all set components and connections are in the qualification database in the same set configuration, the qualification and validation processing module 330 continues to a block 880 to return the set status as meeting FDA qualification requirements.

Alternatively, if the qualification and validation processing module 330 determines at the decision block 830 that all components and connections of the new set are not in the qualification database, the qualification and validation processing module 330 continues to a block 840 to analyze the new set for FDA qualification. The block 840 can include qualification testing of the components or connections, including the bonds, between components of the new set to determine if FDA requirements are satisfied: If the qualification and validation processing module 330 determines at a decision block 850 that the component or connection meets FDA qualification requirements, the qualification and validation processing module 330 continues to a block 860 to add the set components and/or connections to the qualification database for later use in qualifying sets. The qualification and validation processing module 330 continues to the block 880 to return the set status as meeting FDA qualification requirements.

If the qualification and validation processing module 330 determines at the decision block 850 that the component or connection does not meet FDA qualification requirements, the qualification and validation processing module 330 continues to a block 870 to return the set status as unqualified, or not meeting FDA qualification requirements. The qualification and validation process 800 ends at a block 890. In other embodiments, one or more of the blocks in FIG. 8 can be performed by a person trained to conduct FDA qualification procedures. That person may assemble and test samples to determine whether the bonds adhere properly and that the components and their connections meet FDA qualification requirements.

FIG. 9 is a flowchart illustrating a determine other set information process 900 as preferably performed by the determine other set information processing module 340 shown in FIG. 3. The determine other set information processing module 340 determines certain information relating to a set or device once the design has been entered. For example, the determine other set information processing module 340 determines physical properties, such as the overall length of the device or of individual components, or the priming volume in the case of medical devices such as IV sets. In addition, the determine other set information processing module 340 can also include determining the overall cost of the device based on the components making up the set, determining the sterilization method to be used in sterilizing the set, and determining the packaging in which the set or sets are to be shipped to the customer.

The determine other set information process 900 preferably begins at a start block 910. The determine other set information process 900 continues to a block 920 to determine physical properties of the set as designed. Physical properties include measurements and dimensions, for example, the overall length or the priming volume of the set. In calculating dimensions and volumes of the product, overlapping portions of components are designated as such to prevent double counting of such spaces. The physical attributes of each component are preferably stored for each set configuration. The determine other set information processing module 340 preferably continues to a block 930 to determine the overall cost of the set using, among other information, the physical properties determined at the block 920. The calculation of the overall cost of the set can include adding up the design costs, the cost of the individual components making up the set, the cost of bonds or connections, the labor costs associated with assembling the set, the sterilization costs, the packaging costs, delivery costs, and administrative costs.

The determine other set information processing module 340 preferably continues to a block 940 for determining the sterilization method for the set. The sterilization method can differ for different sets made up of various components and connections, but is often the same for similar sets. The determine other set information processing module 340 continues to a block 950 to preferably determine the appropriate packaging for the assembled set, which includes the labeling and warnings to be included with the set. The packaging used can depend on the physical attributes of the set or the shipping method to be employed, for example. The determine other set information process 900 ends at a block 990.

FIG. 10 is a flowchart illustrating an audit process 1000 as preferably performed by the audit processing module 350 shown in FIG. 3. The audit processing module 350 reviews the design, manufacturing, FDA qualification and validation, sterilization, and delivery processes for any deviations from the proper or preferred procedures, or from required procedures as mandated by any applicable FDA regulations. The audit processing module 350 is preferably capable of reviewing the entire design and manufacturing process quickly and accurately from stored information that is readily accessible, and reporting any anomalies or items for further review or investigation.

The audit process 1000 preferably begins at a start block 1010. The audit process 1000 continues to a block 1020 where the audit processing module 350 receives process data for the IV set being reviewed. The process data can include information regarding the design process, manufacturing process, FDA qualification and validation process, sterilization process, and delivery process that was performed for the particular set. The audit processing module 350 continues to a block 1030 to review and analyze the processes performed relating to the device to determine whether proper procedures have been followed in the various phases of the production of the device. In some embodiments, the audit processing module 350 compares the processes actually performed to a set of preferred processes stored on the data storage device 130. Alternatively, a human can perform the comparison and manually record any anomalies. The audit processing module 350 continues to a block 1040 to report any anomalies in the performed processes, for example, by printing out anomalies to the printer 110 or writing the anomalies to a log file on the data storage device 130. The audit process 1000 ends at a block 1090.

FIG. 11 is a flowchart illustrating a non-sterile sample preparation process 1100 as preferably performed by the non-sterile sample preparation processing module 360 shown in FIG. 3. Customers in the medical device market typically request at least one sample of the designed IV set prior to full scale production to confirm the set as designed meets the customers' needs. Since the sample is for review or analysis purposes and is not actually used on a patient, sterilization of the sample set is not required or desired as it would result in an increase in the overall cost and time of producing the device. The non-sterile sample preparation processing module 360 generates a non-sterile sample work order form from the saved set configuration to ensure that the sample set satisfies the design specifications for the IV set.

The non-sterile sample preparation process 1100 preferably begins at a start block 1110. The non-sterile sample preparation processing module 360 continues to a block 1120 to retrieve the saved set configuration, for example, from the data storage device 130. The saved set configuration includes data that depicts the set design. The non-sterile sample preparation processing module 360 continues to a block 1130 to access the component and connection information, as well as other set design information, for the set for which the non-sterile sample is being assembled.

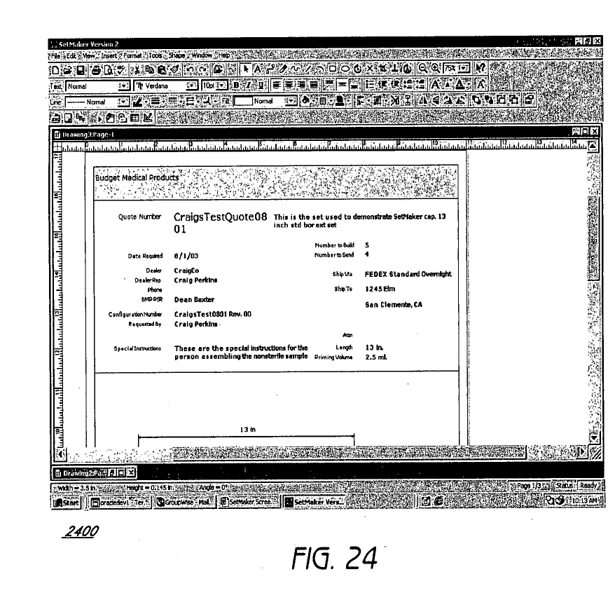

At a block 1140, the non-sterile sample preparation processing module 360 generates the non-sterile sample work order form that preferably includes a graphical diagram of the set design, the list of parts, and the labor steps to be performed in assembling the sample set. An example of the non-sterile sample work order form is illustrated in FIG. 24 and described below. The non-sterile sample preparation processing module 360 continues to a block 1150 to transmit the non-sterile sample work order form to the assembly facility for assembly of the sample set, for example, by transferring a file over a computer network or by facsimile transmission. In some embodiments, the assembly facility for the sample set can be the same as the full scale manufacturing facility. Alternatively, the sample set assembly facility can be at the design facility or at a separate location. The non-sterile sample preparation process 1100 ends at a block 1190.

FIG. 12 is a flowchart illustrating a kit factory preparation process 1200 as preferably performed by the kit factory preparation processing module 370 shown in FIG. 3. The kit factory preparation processing module 370 preferably generates manufacturing orders, orders and receives component parts, and sends the manufacturing orders and corresponding component parts to the assembly location. In some embodiments, the operations of the kit factory preparation processing module 370 are performed at a separate facility referred to as a kit factory. In one alternative, the first two operations (receiving manufacturing orders and component parts) can be performed at the assembly location.

The kit factory preparation process 1200 preferably begins at a start block 1210. The kit factory preparation processing module 370 continues to a block 1220 to generate the manufacturing order for the component parts to be included in the kit from the saved set configuration that has preferably been locked from further modification by the document control processing module 260 as described above. At a block 1230, the kit factory preparation processing module 370 orders and receives parts and components that make up the IV set. The kit factory preparation processing module 370 continues to a block 1240 to send the manufacturing order and component parts in the kit to the assembly location for assembly and delivery. The kit factory preparation process 1200 ends at a block 1290.

FIG. 13 is a flowchart illustrating an assembly preparation process 1300 as preferably performed by the assembly preparation processing module 380 shown in FIG. 3. The assembly preparation processing module 380 sends the necessary assembly information for the medical device to the assembly location in embodiments not having the kit factory preparation processing module 370 described above. This information can include the list of component parts, with part numbers, that compose the completed IV set, the labor steps involved in the assembly of the set, and the desired date for shipping the completed set to the customer. The assembly preparation processing module 380 accesses the saved set configuration to generate the assembly information.

The assembly preparation process 1300 preferably begins at a start block 1310. The assembly preparation processing module 380 continues to a block 1320 to generate the manufacturing order form for the assembly process from the saved set configuration that has preferably been locked from further modification by the document control processing module 260 as described above. At a block 1330, the assembly preparation processing module 380 determines the location for the assembly of the set. The assembly preparation processing module 380 can determine the assembly location based on various factors, for example, lowest cost, quickest time for completion of the order, or a combination of two or more factors. The assembly preparation processing module 380 continues to a block 1340 to send the manufacturing order form to the assembly location determined in the block 1330. The assembly preparation process 1300 ends at a block 1390.

FIG. 14 is a flowchart illustrating the flow of information relating to a post-assembly process 1400 as performed by the post-assembly processing module 390 shown in FIG. 3. The processing module 390 performs a series of operations that are to be performed after assembly of the IV set but prior to shipping the completed set to the customer. For example, the operations performed by the post-assembly processing module 390 can include the sterilization of the IV set in the case of medical devices, and packaging and delivery of the completed device.

The post-assembly process 1400 preferably begins at a start block 1410. The post-assembly process 1400 continues to a block 1420 to inspect the assembled IV set. The processing at the block 1420 can include information relating to various types and levels of quality control or quality assurance to validate the quality and accuracy of the assembled set. The post-assembly processing module 390 continues to a block 1430 for sterilization of the IV set. After assembly but before using an IV set on a patient, the set is sterilized. The sterilization process can take place at the same facility as the assembly location, or the set can be sent to a separate facility for sterilization prior to delivery.

At a block 1440, the post-assembly process 1400 preferably includes information relating to packaging the sterilized set for delivery. The block 1440 also includes the labeling and statements shipped with the set, for example, directions for use, cautions or warnings to prevent accidental misuse or mistakes, patent numbers associated with each component or a combination of components, and miscellaneous statements that provide any additional information or declarations about a component or product. The post-assembly process 1400 continues to a block 1450 for information relating to delivery of the completed set to the customer. The mode of delivery can vary, for example, based on the size of the order, and can include hired truck, express shipping by a carrier such as Federal Express or UPS, or conventional postal mail. In some embodiments, the customer can track the delivery status of an order as described above using the electronic tracking processing 240 (for example, see FIGS. 2 and 5). The post-assembly process 1400 ends at a block 1490.

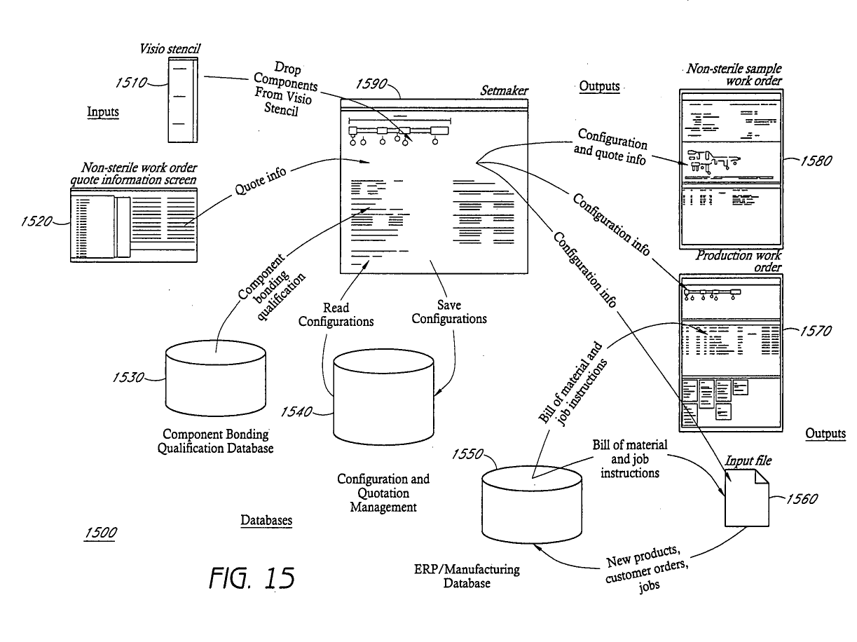

FIG. 15 is a top-level data flow diagram 1500 illustrating the flow of data between various modules, databases and screens of certain embodiments of the computer system for multiple component device design 100 and associated modules shown in FIGS. 1-3. In embodiments utilizing Visio as the graphical design and diagramming program, the user can drag and drop components from a stencil portion 1510 of the Visio screen into the set diagram portion of a set maker screen 1590. The user can build IV sets by dragging and dropping a multitude of component stencils into the diagram portion of the screen.

The non-sterile sample preparation processing module 360 preferably transfers data from a non-sterile work order quote information screen 1520 for display in the set maker screen 1590. In displaying the set maker screen 1590, the set maker processing module 230 retrieves component bonding qualification data, which in some embodiments are stored on a component bonding qualification database 1530. The component bonding qualification database 1530 can be stored on the data storage device 130 (see FIG. 1). The set maker processing module 230 additionally reads saved configuration data, for example, from a configuration and quotation management database 1540, for generating the set maker screen 1590. The configuration and quotation management database 1540 can also be stored on the data storage device 130, or on another data storage device. The set maker processing module 230 stores saved configuration data to the configuration and quotation management database 1540.

The set maker processing module 230 preferably also transfers configuration information to an automated data entry input file 1560 to facilitate the automated entry of set configuration data. Bills of materials and job instructions are also transferred to the automated data entry input file 1560 from an ERP/manufacturing database 1550. As is known to those of ordinary skill in the art, “ERP” refers to Enterprise Resource Planning. Additional configuration information is transferred from the set maker screen 1590 to a production work order screen 1570 generated by the assembly preparation processing module 380. Also accessed for incorporation into the production work order screen 1570 is bill of materials and job instructions data from the ERP/manufacturing database 1550. Configuration and quote information from the set maker screen 1590 is read by the non-sterile sample preparation processing module 360 in generating a non-sterile sample work order 1580. The dataflow of FIG. 15 is an example of certain embodiments of the computer system for multiple component device design 100. In other embodiments, the functionality of the modules can be moved to other modules, resulting in a different dataflow diagram than that shown in FIG. 15.

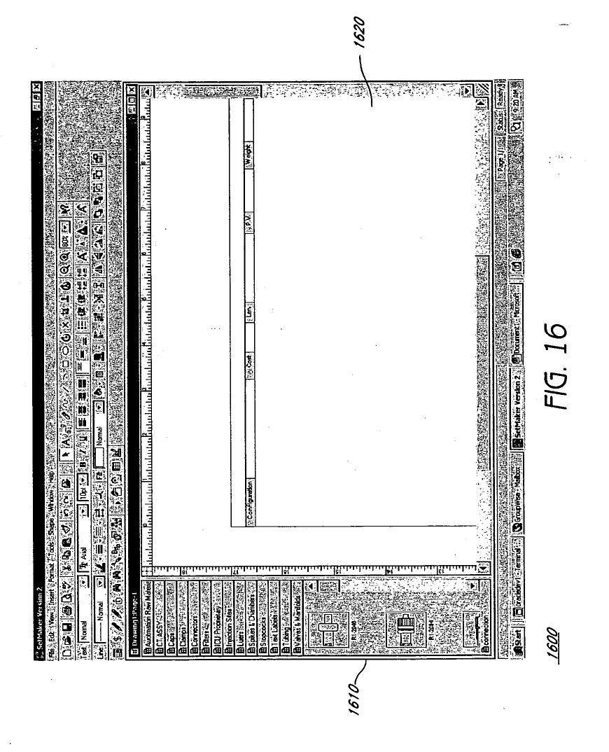

FIG. 16 is a screen shot illustrating one example of a set maker startup screen 1600 in the context of a Visio application platform. The set maker startup screen 1600 includes a stencil selection area 1610 for displaying to the user the template of available stencils and for allowing the user to incorporate one or more of the stencil objects into the device design configuration. As is shown above the stencil selection area 1610, additional stencil selection areas are available for selecting other types of medical components, for example, caps, clamps, connectors, filters, injection sites, luers, stopcocks, and tubing.

The set maker startup screen 1600 also preferably includes a device design and diagramming area 1620. In the design and diagramming area 1620, the user can preferably drag and drop the stencil components that are to make up the medical set being designed. By selecting different stencil objects to drag and drop into the design and diagramming area 1620, the user has flexibility in designing medical sets quickly and easily, as this kind of graphical user interface is logical and intuitive. The device design and diagramming area 1620 shown in FIG. 16 is blank in the case where the designer has not yet incorporated any stencil objects into the device design diagram. Designing medical sets using the design and diagramming area 1620 and the drag and drop capability contributes to the lower time and cost of designing medical sets and other multiple component devices.

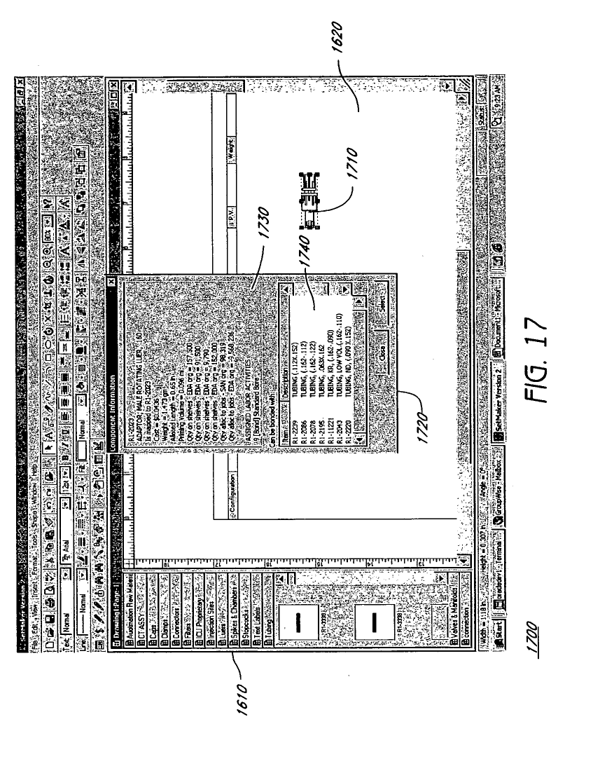

FIG. 17 is a screen shot illustrating one example of a set maker component information screen 1700. The set maker component information screen 1700 includes the stencil selection area 1610 as shown in FIG. 16. The set maker component information screen 1700 additionally includes a medical component 1710 that the user has dragged and dropped from the stencil selection area 1610 into the design and diagramming area 1620 for inclusion into the medical set designed by the user.

The user may wish to view and examine certain detailed information about the various components of the medical set to aid the user in designing the set. The set maker component information screen 1700 preferably includes a component information window 1720 for displaying to the user the detailed information about the selected component. The component information window 1720 includes a display area 1730 for displaying detailed component information such as component number, cost, weight, allocated length, priming volume, quantities in stock, and assigned labor activities. The component information window 1720 also can include a display area 1740 for displaying a list of components that the selected component can be bonded with. In some embodiments, the components available for bonding listed in the display area 1740 only include those components that would meet FDA approval requirements if bonded to the selected component.

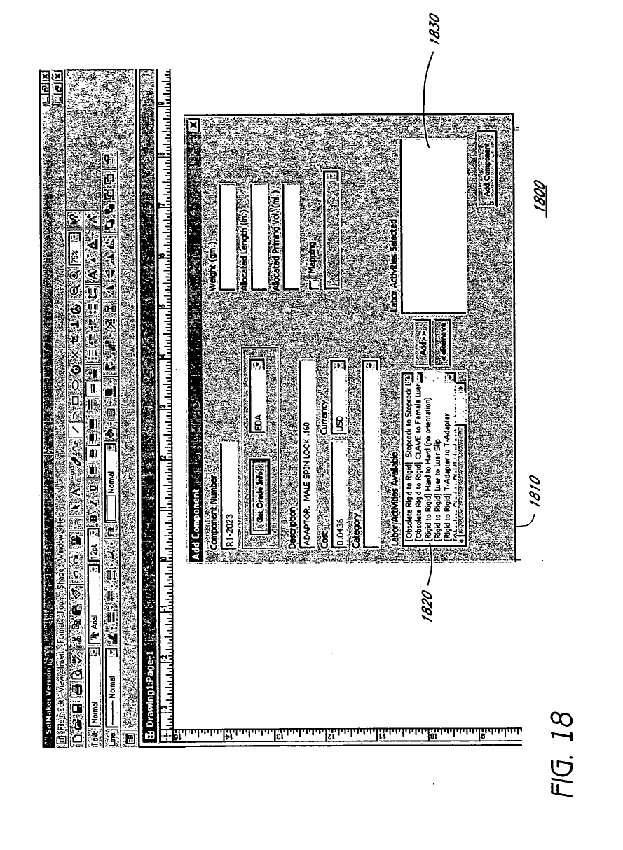

FIG. 18 is a screen shot illustrating one example of a set maker add component screen 1800. The set maker processing module 230 preferably displays the set maker add component screen 1800 upon a request to add an additional component to the stencils. The set maker add component screen 1800 includes an add component window 1810 for displaying information about the component being added to the set of stencils. As shown in FIG. 18, the add component window 1810 can include such component information as component number, description, cost, category, weight, allocated length, and allocated priming volume. In addition, the add component window 1810 can include a list of labor activities available to be performed by the component to be added as shown in a scrolling window 1820. The labor activities listed in the scrolling window 1820 may be added or removed from a window 1830 that shows all labor activities currently selected for the component.

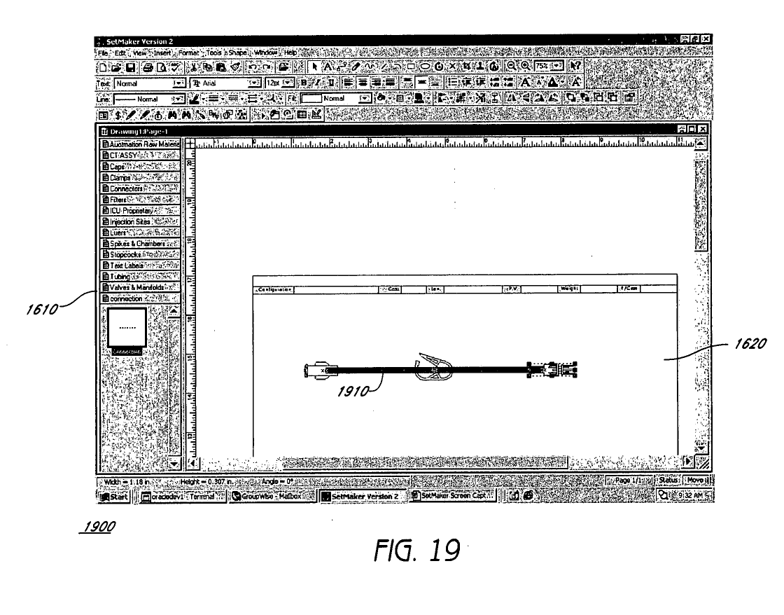

FIG. 19 is a screen shot illustrating one example of a set maker built set screen 1900. The set maker built set screen 1900 can be used by the user to display the design of the set as currently designed. The set maker built device screen 1900 preferably gives the user an overall display view of the set as designed. This screen allows the user to review the configuration of the set, determine if any changes are required or desirable for the set, and make any changes that the user or customer deems necessary. The set maker built device screen 1900 includes the stencil selection area 1610 and the design and diagramming area 1620 for dragging and dropping the stencil objects into the medical set being designed. The set maker built device screen 1900 also preferably includes a built set design diagram 1910 for displaying the set as currently designed for review by the user. By viewing the set as designed, the user can determine if the set meets the design specifications and make any changes to the set that the user or customer may deem to be necessary or that may result in an improved design, for example, one that uses fewer components, less expensive components, or components that can be more easily or quickly procured. The user is able to rapidly determine if the designed set appears satisfactory in meeting the customer's specifications.

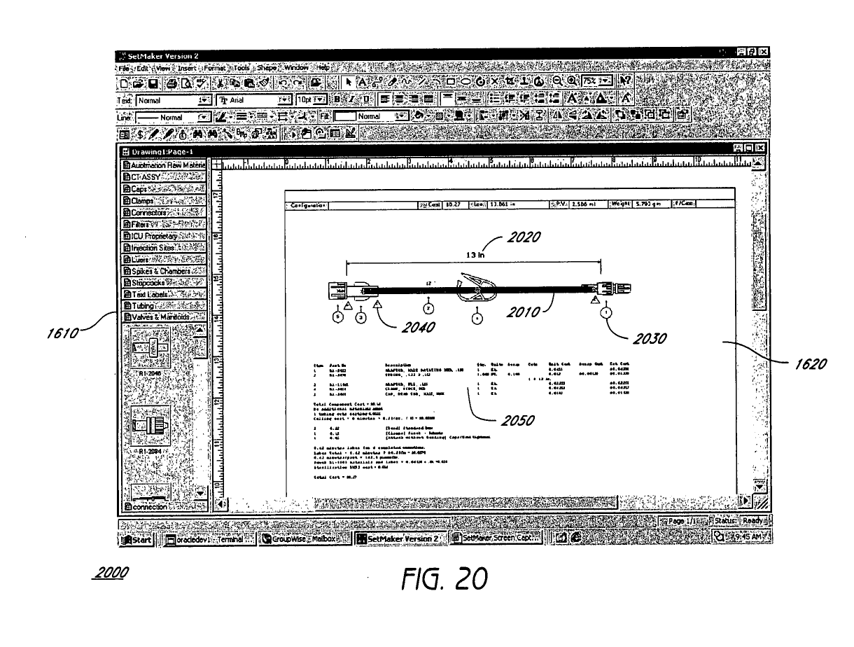

FIG. 20 is a screen shot illustrating one example of a set maker device calculation screen 2000 displaying certain calculations and other information regarding a medical set. When designing a medical set and preparing for its production, the set maker processing module 230 calculates certain data regarding the medical set. The set maker device calculation screen 2000 includes such information that the designer can review to insure the design meets the customer's specifications. The set maker device calculation screen 2000 preferably includes the stencil selection area 1610 and the design and diagramming area 1620 as described above.

The set maker device calculation screen 2000 also preferably displays a set design diagram 2010 that includes an overall length calculation 2020 of the set as designed. The overall length calculation can be used in determining the size and physical dimensions of the set as designed and the ease of use of the medical set. The set design diagram 2010 also preferably includes a numeric identifier 2030 for each component making up the set. The numeric identifier 2030 can be used as a reference identifier for the individual components in a set. The set design diagram 2010 can also include a bond identifier 2040 that is used as a reference identifier for the individual bonds connecting components together in the set.

The set maker device calculation screen 2000 can also preferably display a textual set description area 2050. The textual set description area 2050 displays information and calculations of the set shown in the corresponding set design diagram 2010 in a textual format. The textual set description area 2050 can include, for example, a list of the component parts in the set with various information on each part, bond information for the connection of components in a set, sterilization information, and total cost for the set as designed. Additional textual information can be displayed by programming additional write commands corresponding to the additional information for display on the set maker device calculation screen 2000.

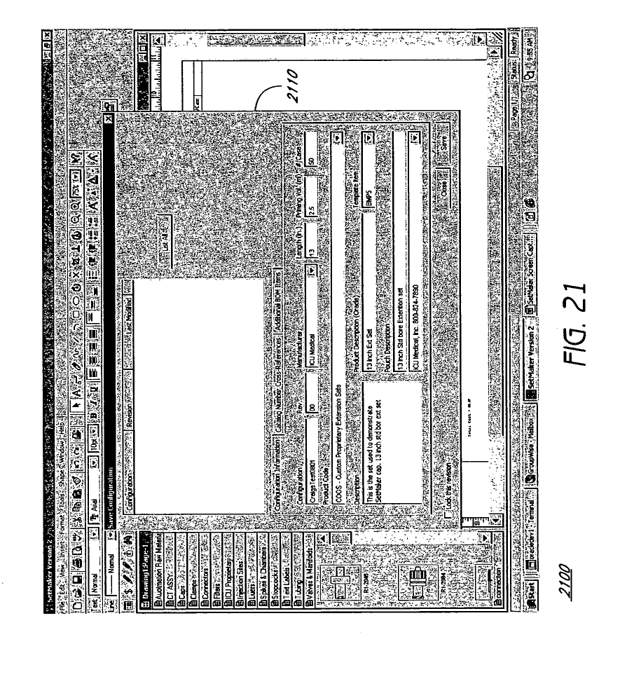

FIG. 21 is a screen shot illustrating one example of a set maker save screen 2100 for saving the configuration data describing a set. The set maker processing module 230 can save the set configuration information, for example, on the data storage device 130. The user can close a set design that is in process for many reasons, such as to switch to working on another set design, to leave work for the day, or when the user believes the set design is complete. The user can open the saved configuration at some later time to review or further modify the set configuration. For example, the user may switch back to working on the set design, or the customer may provide additional specifications or modifications to the set design. The saved configuration can also be provided to personnel involved in other steps in the design and manufacturing process, such as document control, FDA approval, manufacturing, or sterilization. Still further, the set designer can use the saved configurations in designing new sets that are similar or identical to previously designed sets so that the designer often does not have to start new designs from the beginning stage.

The set maker save screen 2100 preferably includes a save configuration screen 2110 that displays information on the set configuration that the user has requested to save. The save configuration screen 2110 displays information that the set maker processing module 230 calculates for the set, as well as information the user enters for the set. For example, the save configuration screen 2110 can display length and priming volume data calculated by the set maker processing module 230. The save configuration screen 2110 can additionally display information the user enters, such as a textual description of the set, the name of the set, or the manufacturer of the set. The save configuration screen 2110 can include configuration information as described above, catalog number cross-reference information for cross-referencing to other vendor's medical components, or additional bill of materials item information.

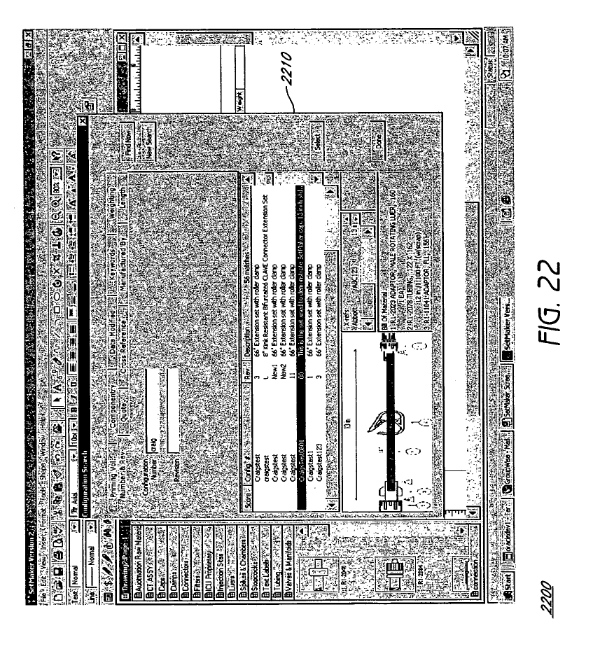

FIG. 22 is a screen shot illustrating one example of a set maker find screen 2200 for searching and locating previously saved set configuration data. The users can save set configurations for a variety of reasons, for example, to switch working from one set to another set. In addition, the user can save the set configuration once the design is deemed to be complete. The user can continue working on saved configurations by opening the corresponding file or files in which the configuration is saved. The user can also access saved configurations to use as a starting point for designing a new medical set that is similar to a saved set configuration. Thus, the user often is able to design a new set without having to start from the beginning, but rather starting from an existing set design that is similar or identical, thus requiring less time or effort to complete the design. In some embodiments, the set maker processing module 230 stores saved configurations in a configuration management database on the data storage device 130.

The set maker find screen 2200 preferably includes a configuration search screen 2210. By using the configuration search screen 2210, the user can enter different search criteria for use in searching the saved configurations and returning those that match. For example, the search criteria can include set number and revision number, quote information, cross reference information to other vendors' components, the name of the manufacturer, set length, weighting information, keywords (such as in the product's description), date of modification, componentry, and set priming volume. FIG. 22 shows a set number and revision number search, where the user selected to search for saved configurations for which the configuration number begins with the text “craig.” The configuration search screen 2210 can include a list of saved configurations matching the search criteria, with the description being displayed for each matching configuration. The configuration search screen 2210 can additionally include the set design diagram for the configuration that the user selected from the list of saved configurations. The configuration search screen 2210 can also include additional information for the saved configuration such as a bill of materials.

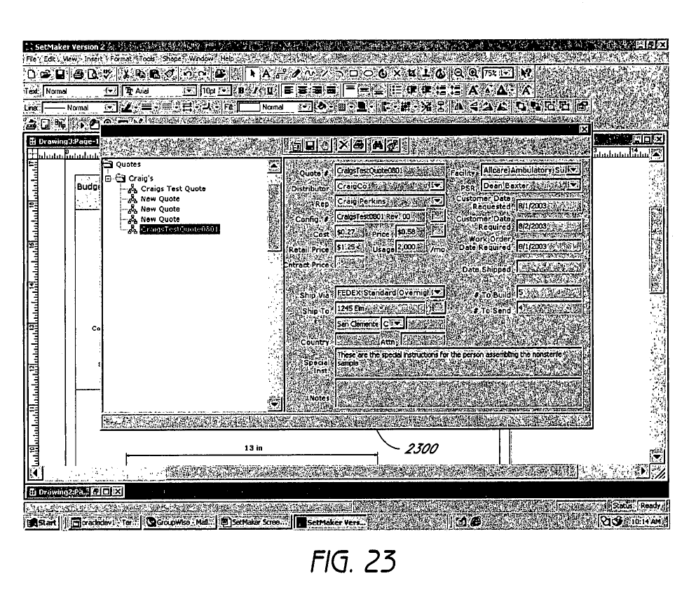

FIG. 23 is a screen shot illustrating one example of a set maker configuration data screen 2300 for displaying certain data regarding a saved set configuration. The set maker processing module 230 can display the set maker configuration data screen 2300 by compiling data from a multitude of screens when the user requests the display of information on a particular set configuration. The set maker configuration data screen 2300 includes a list of electronic folders or quote files from which the user can select a particular quote file for which to receive the detailed quote information. For example, the detailed quote information can include the quote number, the distributor, the configuration number, cost and price information, shipping information, the requested and required dates of delivery to the customer, the number of sets to be produced, and any special instructions, for example, for the manufacturing or sterilization processes.

FIG. 24 is a screen shot illustrating one example of a non-sterile sample work order screen 2400 for a saved set configuration. Once the user completes the initial design of the set, the customer can request to receive an assembled prototype of the set for inspection and analysis purposes. Since the prototype set is for inspection or review purposes and will not be used in the treatment of a patient, sterilization is not required. The non-sterile sample preparation processing module 360 generates the non-sterile sample work order screen 2400, which includes information relating to the assembly of the prototype to be sent to the customer.

The information on the non-sterile sample work order screen 2400 can include the quote number, dealer information, configuration number, requester name, the number of sets to build and send, shipping information, set length, and set priming volume. The non-sterile sample work order screen 2400 can also include the set design diagram that illustrates graphically the components making up the set. In addition, the non-sterile sample work order screen 2400 can include the bill of materials or similar parts list information for the set such as instructions for the assembly of the set.

FIG. 25 is a screen shot illustrating one example of a one page work order screen 2500 for a saved set configuration. A set that has been designed, approved by the customer, and met FDA approval, is typically ready to begin assembly at the manufacturing facility. To facilitate assembly and ensure accuracy between the set as designed and as manufactured, the manufacturing work order processing module 210 generates a work order form, preferably a one-page work order form such as that illustrated in FIG. 25. The one-page work order form includes information used to complete assembly of the set at the manufacturing facility in a concise, easy-to-read format.

The one-page work order form 2510 preferably includes information to identify the set being assembled, for example, the item number, revision number, job number, production quantity, and textual description of the set, as shown at the top of the one-page work order form 2510 in FIG. 25. The one page work order form 2510 additionally includes the set design diagram graphically illustrating the set as designed and assembled. The one-page work order form 2510 also includes a list of the components making up the set, and a list of labor steps to be performed in assembling the set. The user can select to print out the one-page work order form 2510 in hardcopy form to the printer 110 (see FIG. 1).

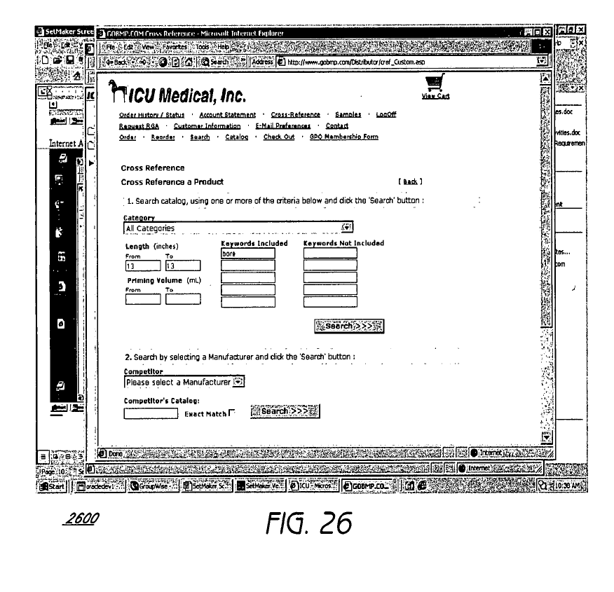

FIG. 26 is a screen shot illustrating one example of a product cross reference search screen 2600 for identifying and locating products, components, and configurations thereof that have previously been processed and stored in a database (preferably using one or more of the tools disclosed herein), or that are substantially equivalent or interchangeable with a competitor's products or components. In effect, the product cross reference search screen 2600 demonstrates a “short cut” for identifying previously prepared product configurations without the need to repeat steps such as the product configuration build-up and government regulation validation. The product cross reference search screen 2600 is generated and displayed by the cross reference processing module 324. Customers who are familiar with sets or components of a competitor (for example, from previously ordering a set from a competitor) can also use the product cross reference screen 2600 to gain information about the hosting company's products that are similar or equivalent and may be persuaded to purchase sets from the hosting company instead of the products made by competitors. In some embodiments, the cross reference information is accessible by a potential customer via a public network, for example, by accessing a website on the Internet. Preferably, individual access to such a website requires passwords and/or other qualifiers to ensure that the database is accessed by specified individuals only, such as authorized distributors, and not misused by others.

The product cross reference screen 2600 includes one or more ways to search for a similar or interchangeable product. For example, FIG. 26 illustrates an example of accessing the product cross reference screen 2600 at a website. Using the product cross reference screen 2600, the customer can search for products by entering categories of the product, keyvords, set length, or set priming volume. Alternatively, the customer can search for products by entering a particular manufacturer of the product. As will be recognized by those of skill in the art after reading this disclosure, other searching categories can also be used.

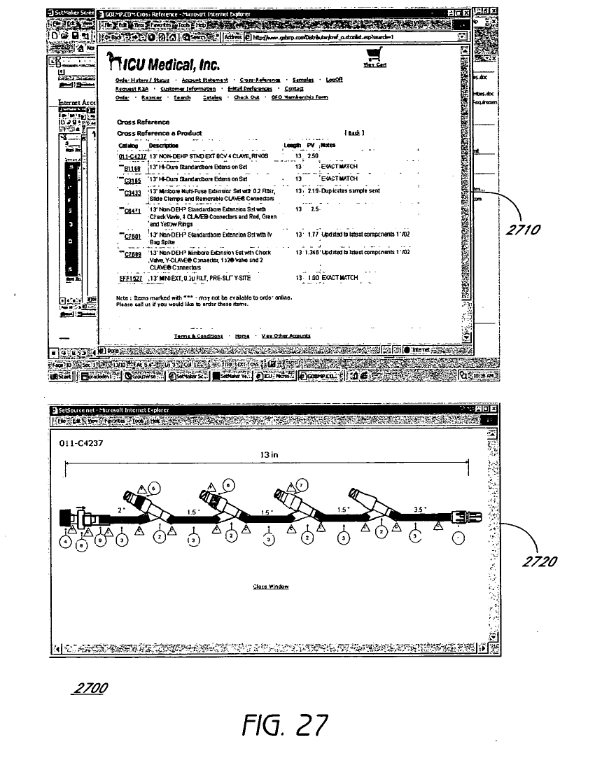

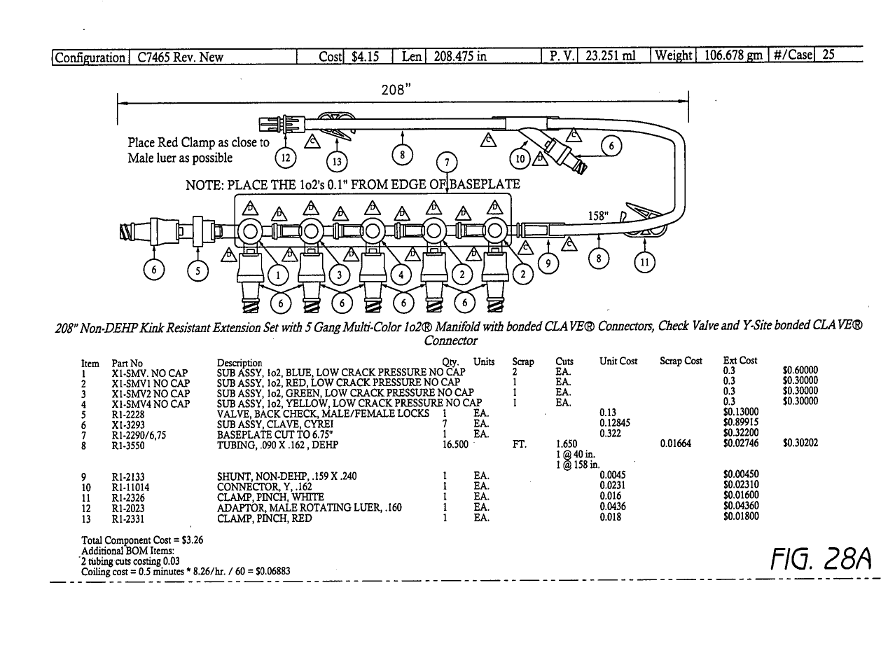

FIG. 27 is a screen shot illustrating one example of several cross reference results screens 2700 for displaying product cross-reference information resulting from a cross reference search as shown in FIG. 26. By reviewing detailed information on a particular product matching the cross reference search as described above, the user or customer can determine whether the matching product can be ordered in place of the previously known or used product of the competitor.

The cross reference processing module 324 preferably generates the cross reference results screens 2700, which include a components list screen 2710 showing the matching product and a set design diagram screen 2720 graphically displaying a diagram of the configuration of the potentially matching set. The components list screen 2710 displays information on the components making up a set matching the cross reference search criteria. This information can include, for example, the catalog number of each component, the textual description, the length and priming volume, and notes associated with each component. In addition, the set design diagram screen 2720 displays the diagram of the set matching the cross reference search. Thus, as shown in FIG. 27, for sets matching the cross reference search criteria, the cross reference processing module 324 can display the textual list of components as well as the graphical representation of the set diagram.

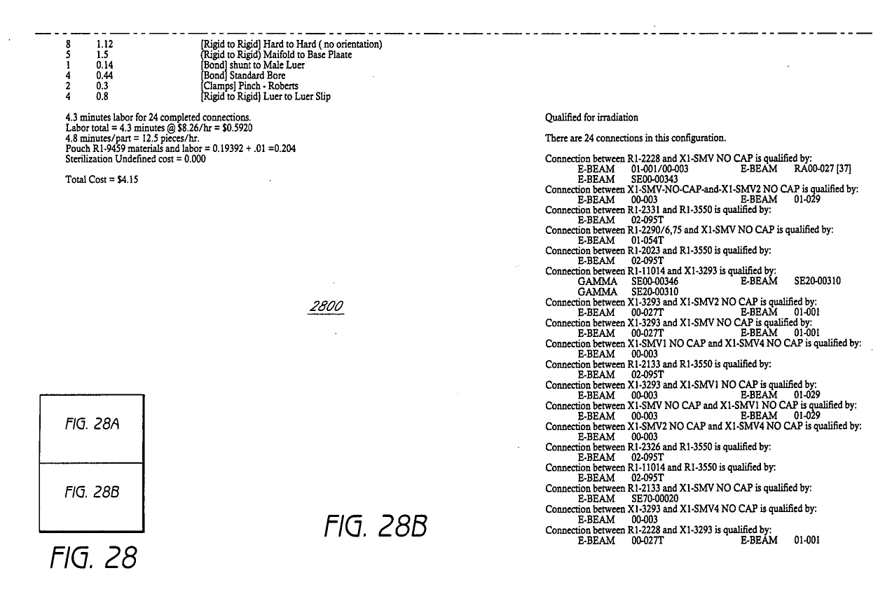

FIG. 28, split into FIGS. 28A and 28B, illustrates one example of a component information portion 2800 of a component information screen (not shown) for displaying various component, connection, and cost information for an IV set. In addition to the set design diagram and component list information, the component information portion 2800 also includes cost information for the set. The cost information preferably includes such information as unit cost, scrap cost, and external cost for the listed components. Additional cost information for display in the component information portion 2800 can include cost information for tubing and coiling, total labor time and cost, sterilization cost, and total cost for the set including all parts, labor, sterilization and packaging costs. Also included in the component information portion 2800 is a list of connections in the set as configured.

The screen shots illustrated in FIGS. 16-28 are examples of the multitude of screen displays that could be implemented. Other screen displays could also be used, displaying similar information in a different format, or displaying different information.

While the above detailed description has shown, described, and pointed out novel features of the invention as applied to various embodiments, it will be understood that various omissions, substitutions, and changes in the form and details of the device or process illustrated may be made by those of ordinary skill in the technology without departing from the spirit of the invention. This invention may be embodied in other specific forms without departing from the essential characteristics as described herein. The embodiments described above are to be considered in all respects as illustrative only and not restrictive in any manner. The scope of the invention is indicated by the following claims rather than by the foregoing description.

What is claimed is:

1. A graphical method of designing a multi-component medical device, the method comprising:
providing a project screen;
retrieving a first component schematic from a graphical program screen and positioning it within the project screen;
retrieving a second component schematic from the graphical program screen and positioning it within the project screen;
retrieving data from a qualification database and positioning it within the project screen;
retrieving configuration data and using that data to assist in generating the project screen; and
providing a data entry input file.

2. The method of claim 1, further comprising retrieving data from a quotation management database and positioning it within the project screen.

3. The method of claim 2, wherein configuration data is retrieved from a configuration and quotation management database.

4. The method of claim 1, wherein providing a project screen comprises providing a setmaker screen.

5. The method of claim 1, wherein retrieving a first component schematic from a graphical program screen comprises retrieving a stencil of a first component from a visio program screen and positioning it within the project screen.

6. The method of claim 1, further comprising transferring a list of materials to the data entry input file.

7. The method of claim 1, further comprising transferring job instructions to the data entry input file.

8. The method of claim 1, further comprising providing a non-sterile work order quote information screen.

9. The method of claim 1, further comprising retrieving data displayed on a project screen for use in a non-sterile sample work order.

10. The method of claim 1, further comprising retrieving data displayed on a project screen for use in a non-sterile production work order.
